(19) United States
(12) Patent Application Publication
(10) Pub. No.: US 2025/0279713 A1
(43) Pub. Date: Sep. 4, 2025

(54) VOLTAGE HOLDING CIRCUIT, VOLTAGE HOLDING METHOD, POWER CIRCUIT AND ELECTRONIC DEVICE

(71) Applicant: SHENZHEN MEGMEET ELECTRICAL CO., LTD., Shenzhen (CN)

(72) Inventors: Tao XIAO, Shenzhen (CN); Chung Hei Albert POON, Shenzhen (CN); Zhongliang LIANG, Shenzhen (CN)

(73) Assignee: SHENZHEN MEGMEET ELECTRICAL CO., LTD., Shenzhen (CN)

(21) Appl. No.: 19/021,119

(22) Filed: Jan. 14, 2025

(30) Foreign Application Priority Data
Mar. 1, 2024 (CN) 202410234767.4

(51) Int. Cl. H02M 1/00; H02M 1/32; H02M 3/157; H02M 3/158

(52) U.S. Cl. CPC H02M 1/0032; H02M 1/0096; H02M 1/32; H02M 3/157; H02M 3/1582

(57) ABSTRACT

A voltage holding circuit, a voltage holding method, a power circuit and an electronic device are provided. The voltage holding circuit includes a first energy storage circuit and a voltage conversion circuit coupled between the first energy storage circuit and a second energy storage circuit to receive the input voltage from the second energy storage circuit, boost and output the input voltage to the first energy storage circuit when the input voltage is within a first threshold range, and output the first energy storage voltage of the first energy storage circuit to the second energy storage circuit when the input voltage is lower than the first threshold range and/or the drop rate of the input voltage is within a preset threshold range to extend the hold-up time of the second energy storage voltage of the second energy storage circuit within the first threshold range.

### CROSS-REFERENCE TO RELATED APPLICATION

The present application claims the benefit of priority to Chinese Patent Application No. 202410234767.4, filed on Mar. 1, 2024, which is hereby incorporated by reference in its entirety.

### TECHNICAL FIELD

The embodiments of this application relate to a power management technology field, and more particularly, to a voltage holding circuit, a voltage holding method, a power circuit and an electronic device.

### TECHNICAL BACKGROUND

At present, in practical application of power circuits, there is usually a need for power-outage holding or low-voltage input compensation. That is to say, when the input voltage of a load provided by a power circuit drops, the load shall hold the current work voltage for a certain period to complete necessary work in a timely manner during holding voltage. For example, in case of power outage of a storage medium, in order to avoid irreversible losses such as data loss caused by cache failure, it is usually necessary to hold the power output to the storage medium for a certain period when the storage medium is powered off.

Wherein, the common methods of power-outage holding or low-voltage input compensation are to increase storage capacitance in a power circuit or to increase voltage when the storage capacitor discharges. However, when the capacitance increases, costs and sizes of power circuits will also increase proportionally, which contradicts the trend of smaller size and lower cost in the market. When increasing the capacitor voltage during discharge, in case of low-voltage output, it is generally necessary to add a boost circuit to boost the input voltage to a voltage level to store enough energy to cope with the voltage output holding. Consequently, sizes and costs of power circuits will also significantly increase. In addition, due to the increase of work voltage, the requirement for rated voltage of all power circuit components also becomes higher.

### SUMMARY

The embodiments of this application provide a voltage holding circuit, a voltage holding method, a power circuit and an electronic device which can solve the problem that the significant increase of costs and sizes of power circuits in related art during power-outage holding and low-voltage input compensation contradicts with the trend of smaller sizes and lower costs in the market.

A technical scheme of the application for solving the above technical problem is to provide a voltage holding circuit, wherein the voltage holding circuit includes a first energy storage circuit and a voltage conversion circuit coupled between the first energy storage circuit and an external second energy storage circuit to receive the input voltage from the second energy storage circuit, boost and output the input voltage to the first energy storage circuit when the input voltage is within a first threshold range, and output the first energy storage voltage of the first energy storage circuit to the second energy storage circuit when the input voltage is lower than the first threshold range and/or the drop rate of the input voltage is within a preset threshold range to extend the hold-up time of the second energy storage voltage of the second energy storage circuit within the first threshold range.

Wherein, when the first energy storage voltage is within a second threshold range, the voltage conversion circuit stops boosting and outputting to the first energy storage circuit, and when the first energy storage voltage is lower than the second threshold range, the voltage conversion circuit boosts and outputs the input voltage to the first energy storage circuit.

Wherein, the voltage conversion circuit includes a third energy storage circuit, a first switch sub-circuit, a second switch sub-circuit and a control circuit; the third energy storage circuit is coupled with the second energy storage circuit, the first switch sub-circuit and the second switch sub-circuit, the first switch sub-circuit is coupled with the second switch sub-circuit, the first energy storage circuit and the control circuit, the second switch sub-circuit is coupled with the control circuit, and the control circuit is coupled with the second energy storage circuit; wherein, the third energy storage circuit receives the input voltage from the second energy storage circuit, and the control circuit obtains the input voltage by sampling, triggers the second switch sub-circuit ON at a set interval, superposes the third energy storage voltage of the third energy storage circuit with the input voltage and stores them into the first energy storage circuit when the input voltage is within the first threshold range, triggers the first switch sub-circuit ON and the second switch sub-circuit OFF and outputs the first energy storage voltage to the second energy storage circuit when the input voltage is lower than the first threshold range and/or the drop rate of the input voltage is within the preset threshold range.

Wherein, the voltage conversion circuit also includes a protection sub-circuit coupled between the second switch sub-circuit and the first energy storage circuit to limit the current between the second switch sub-circuit and the first energy storage circuit within a third threshold range.

Wherein, the voltage conversion circuit also includes a first sampling circuit coupled with the first energy storage circuit and the control circuit to obtain the first energy storage voltage by sampling and send the first energy storage voltage to the control circuit; and/or, the voltage conversion circuit also includes a second sampling circuit coupled with the second energy storage circuit and the control circuit to obtain the input voltage by sampling and send the input voltage to the control circuit.

Wherein, the control circuit includes a first signal processing sub-circuit and a drive sub-circuit; the first signal processing sub-circuit is coupled with the second sampling circuit and the drive sub-circuit, and the drive sub-circuit is coupled with the first switch sub-circuit and the second switch sub-circuit; the first signal processing sub-circuit receives the input voltage from the second sampling circuit, generates a second control signal based on the input voltage and/or the voltage drop rate and sends the second control signal to the drive sub-circuit, and the drive sub-circuit sends a second drive signal to the second switch sub-circuit to trigger the second switch sub-circuit ON or OFF; and/or, the first signal processing sub-circuit is also coupled with the first sampling circuit; the first signal processing sub-circuit receives the first energy storage voltage from the first sampling circuit, generates a first control signal based on the first energy storage voltage and sends the first control signal to the drive sub-circuit, and the drive sub-circuit sends a first drive signal to the first switch sub-circuit to trigger the first switch sub-circuit ON or OFF.

Wherein, the control circuit includes a second signal processing sub-circuit, a first comparison circuit, a third switch sub-circuit and a drive sub-circuit; the second signal processing sub-circuit is coupled with the third switch sub-circuit and the drive sub-circuit, and the first comparison circuit is coupled with the second sampling circuit and the third switch sub-circuit; the first comparison circuit receives the input voltage from the second sampling circuit, obtains a first comparison signal by comparing the input voltage with a first reference voltage and sends the first comparison signal to the third switch sub-circuit to trigger the third switch sub-circuit ON or OFF, the second signal processing sub-circuit sends a third control signal to the drive sub-circuit when the third switch sub-circuit is OFF and the drive sub-circuit sends a third drive signal to the second switch sub-circuit under the action of the third control signal to trigger the second switch sub-circuit ON or OFF; and/or, the control circuit also includes a second comparison circuit and a fourth switch sub-circuit; the second comparison circuit is coupled with the first sampling circuit, the fourth switch sub-circuit and the second signal processing sub-circuit; the second comparison circuit receives the first energy storage voltage from the first sampling circuit, obtains a second comparison signal by comparing the first energy storage voltage with a second reference voltage and sends the second comparison signal to the fourth switch sub-circuit to trigger the fourth switch sub-circuit ON or OFF; the second signal processing sub-circuit sends a fourth control signal to the drive sub-circuit when the fourth switch sub-circuit is OFF; the drive sub-circuit sends a fourth drive signal to the first switch sub-circuit under the action of the fourth control signal to trigger the first switch sub-circuit ON or OFF.

Wherein, the first comparison circuit includes a first resistor, a second resistor and a first comparator, and the third switch sub-circuit includes a third switching tube; the first end of the first resistor is coupled with the first end of the first energy storage circuit, the second end of the first resistor is coupled with the first end of the second resistor and the first end of the first comparator, the second end of the second resistor is coupled with the third end of the first comparator and the first end of the third switching tube and is grounded, the second end of the first comparator is coupled with the second reference voltage supply end, the fourth end of the first comparator is coupled with a set level supply end, the fifth end of the first comparator is coupled with the third end of the third switching tube, and the second end of the third switching tube is coupled with the first end of the second signal processing sub-circuit and the first end of the drive sub-circuit; and/or, the second comparison circuit includes a third resistor, a fourth resistor and a second comparator, and the fourth switch sub-circuit includes a fourth switching tube; the first end of the third resistor is coupled with the first end of the second energy storage circuit, the second end of the third resistor is coupled with the first end of the fourth resistor and the first end of the second comparator, the second end of the fourth resistor is coupled with the third end of the second comparator and the first end of the fourth switching tube and is grounded, the second end of the second comparator is coupled with the first reference voltage supply end, the fourth end of the second comparator is coupled with the set level supply end, the fifth end of the second comparator is coupled with the third end of the fourth switching tube, and the second end of the fourth switching tube is coupled with the second end of the second signal processing sub-circuit and the second end of the drive sub-circuit.

Wherein, the first comparison circuit also includes a fifth resistor, of which the first end is coupled with the first end of the first comparator and the second end is coupled with the fifth end of the first comparator; and/or, the second comparison circuit also includes a six resistor, of which the first end is coupled with the first end of the second comparator and the second end is coupled with the fifth end of the second comparator.

Wherein, the voltage conversion circuit also includes a peripheral circuit which is coupled with the drive sub-circuit and the first switch sub-circuit.

Wherein, the first energy storage circuit includes a storage capacitor, the second energy storage circuit includes an input capacitor, the third energy storage circuit includes a first inductor, the first switch sub-circuit includes a first switching tube and the second switch sub-circuit includes a second switching tube; the first end of the input capacitor is coupled with the second energy storage circuit and the first end of the first inductor, the second end of the first inductor is coupled with the second end of the first switching tube and the first end of the second switching tube, the first end of the first switching tube is coupled with the first end of the storage capacitor, the second end of the input capacitor is coupled with the second end of the second switching tube and the second end of the storage capacitor and is grounded, the third end of the first switching tube is coupled with the first end of the control circuit, and the third end of the second switching tube is coupled with the second end of the control circuit.

Another technical scheme of the application for solving the above technical problem is to provide a voltage holding method, wherein the voltage holding method includes receiving the input voltage from the second energy storage circuit; detecting whether the input voltage is within the first threshold range and whether the drop rate of the input voltage is within the preset threshold range; boosting and outputting the input voltage to the first energy storage circuit when the input voltage is within the first threshold range; and outputting the first energy storage voltage of the first energy storage circuit to the second energy storage circuit and boosting the second energy storage voltage of the second energy storage circuit to the value within the first threshold range when the input voltage is lower than the first threshold range, and/or the drop rate of the input voltage is within the preset threshold range.

Wherein, the step of boosting and outputting the input voltage to the first energy storage circuit also includes detecting whether the first energy storage voltage is within the second threshold range; if yes, stopping the boosting output to the first energy storage circuit; and if no, boosting and outputting the input voltage to the first energy storage circuit.

Wherein, the step of boosting and outputting the input voltage to the first energy storage circuit includes storing the input voltage to the third energy storage circuit; and superposing the third energy storage voltage of the third energy storage circuit with the input voltage, and storing them to the first energy storage circuit.

Another technical scheme of the application for solving the above technical problem is to provide a power circuit, wherein the power circuit includes a second energy storage circuit and a voltage holding circuit, and the second energy storage circuit is coupled with the voltage holding circuit and an external power source to receive the input voltage from the power source and sends the input voltage to the voltage conversion circuit; wherein, the voltage holding circuit is one in any of above claims.

Another technical scheme of the application for solving the above technical problem is to provide an electronic device, wherein the electronic device includes a shell and a signal processing circuit; wherein, the signal processing circuit is the voltage holding circuit in any of above claims or the power circuit in above claims.

The beneficial effect of the embodiments of this application is that different from related arts, the voltage conversion circuit of the voltage holding circuit in this application receives the input voltage from the second energy storage circuit, boosts and outputs the input voltage to the first energy storage circuit when the input voltage is within a first threshold range, and outputs the first energy storage voltage of the first energy storage circuit to the second energy storage circuit when the input voltage is lower than the first threshold range and/or the drop rate of the input voltage is within a preset threshold range to effectively extend the hold-up time of the second energy storage voltage of the second energy storage circuit within the first threshold range. Therefore, it can effectively realize power-outage holding or low-voltage input compensation without installing additional energy storage components or increasing the energy storage voltage during discharge. It can also respond to the drop of the input voltage and/or the drop trend of the input voltage to quickly boost the voltage of the second energy storage circuit with low cost and small size. It is convenient for smaller sizes and lower costs. In addition, a voltage conversion circuit for both boosting and bucking can effectively save circuit components and reduce the size of energy storage components with a view to effectively simplifying the circuit control.

### BRIEF DESCRIPTION OF DRAWINGS

To provide an explanation of the technical schemes in the embodiments of this application, a brief introduction will be given to the accompanying drawings required in the description of the embodiments. Obviously, the accompanying drawings in the following description are only some embodiments of the application. A person skilled in the art can obtain other drawings based on these drawings without putting in creative labor.

FIG. 1 illustrates a structural schematic diagram of the first embodiment of the voltage holding circuit in this application;

FIG. 2 illustrates a structural schematic diagram of the second embodiment of the voltage holding circuit in this application;

FIG. 3 illustrates a structural schematic diagram of an embodiment of a part of the voltage holding circuit in FIG. 2;

FIG. 4 illustrates a structural schematic diagram of an embodiment of the voltage conversion circuit of the voltage holding circuit in FIG. 2;

FIG. 5 illustrates a structural schematic diagram of the third embodiment of the voltage holding circuit in this application;

FIG. 6 illustrates a structural schematic diagram of an embodiment of the voltage conversion circuit of the voltage holding circuit in FIG. 5;

FIG. 7 illustrates a framework schematic diagram of a signal processing logic of a voltage delay holding circuit;

FIG. 8 illustrates a process flow schematic diagram of an embodiment of the voltage holding method in this application;

FIG. 9 illustrates a process flow schematic diagram of an embodiment of S43 in FIG. 8;

FIG. 10 illustrates a process flow schematic diagram of another embodiment of S43 in FIG. 8;

FIG. 11 illustrates a framework schematic diagram of an embodiment of the power circuit in this application; and

FIG. 12 illustrates a framework schematic diagram of an embodiment of the electronic device in this application.

### DETAILED DESCRIPTION

After long-term researches, it is found that in practical application of power circuits, there is a need for holding voltage in power outage. That is to say, when the input voltage of a load provided by a power circuit drops, the load shall hold the current work voltage for a certain period to complete necessary work in a timely manner during holding voltage. For example, in case of power outage of a storage medium, in order to avoid irreversible losses such as data loss caused by cache failure, it is usually necessary to hold the power output to the storage medium for a certain period when the storage medium is in power outage.

It can be concluded based on the formula for capacitance energy storage and the law of energy conservation that: W(in)=0.5*C*(Vh²−Vl²), W(out)=Pout*Thold/Eff, W(in)=W(out). Where, W(in): input energy; C: capacitance; Vh: discharge voltage of storage capacitor; Vl: the minimum storage capacitor voltage to hold voltage output conditions, Vl=Vin_min/D_buck (D_buck is the duty ratio of the buck drive voltage); W(out): output energy+loss; Pout: output power; Thold: voltage output hold-up time; Eff: efficiency of system.

It can be obtained from the above formula that when other parameters remain unchanged, conventional solutions to increase the voltage output hold-up time Thold include increase of the capacitance C and increase of the discharge voltage of storage capacitor Vh.

However, when the capacitance C increases, costs and sizes of power circuits will also increase proportionally, which contradicts the trend of smaller size and lower cost in the market. When increasing the discharge voltage of storage capacitor Vh, in case of low voltage output, it is generally necessary to add a boost circuit to boost the input voltage to a voltage level to store enough energy to cope with the voltage output holding. Consequently, sizes and costs of power circuits will also significantly increase. In addition, due to the increase of work voltage, the requirement for rated voltage of all power circuit components also becomes higher.

There is also another solution in the market, i.e., install a transformer in a power circuit and add a primary high-voltage winding to the transformer, to boost the input or output voltage at the transformer coil ratio and store the voltage into the high-voltage winding. When the input voltage drops, the high-voltage winding is controlled to release the stored energy into the system to hold the output. However, this solution also obviously increases costs and sizes of power circuits.

To effectively hold voltage in power outage without increasing hardware costs, embodiments of this application provide a voltage holding circuit. By combining the accompanying drawings and embodiments, a more detailed description of this application will be given. It should be noted that the following embodiments are only used to illustrate this application, but do not limit the scope of this application. Similarly, the following embodiments are only some, not all, embodiments in this application. All other embodiments obtained by a person skilled in the art without creative labor are within the scope of protection of this application.

The term “embodiment” in this application means that specific features, structures or characteristics described by combining the embodiments may be included in at least one embodiment in this application. The term in different positions in the specifications is not necessarily the same embodiment, nor an independent or alternative embodiment that is exclusive with other embodiments. A person skilled in the art explicitly and implicitly understands that the embodiments described in this application can be combined with other embodiments.

A detailed explanation of this application is provided below by combining the drawings and embodiments.

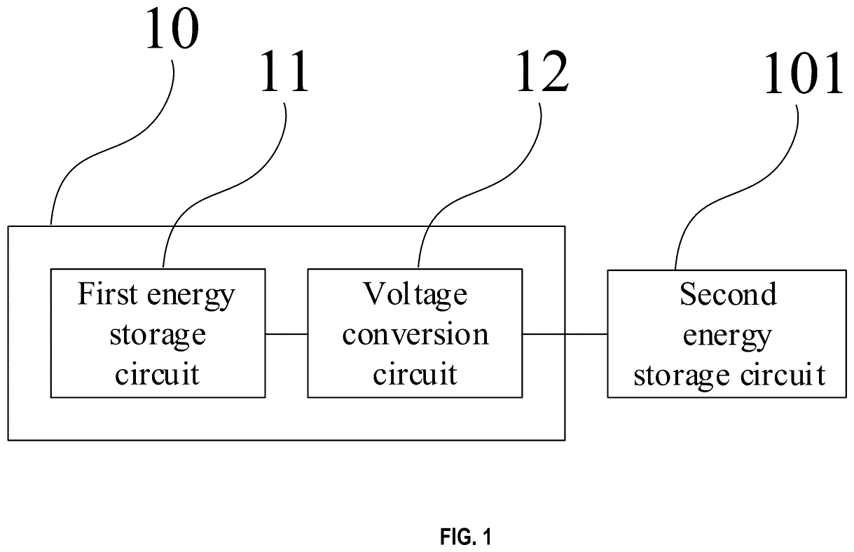

Referring to FIG. 1, FIG. 1 illustrates a structural schematic diagram of the first embodiment of the voltage holding circuit in this application. In this embodiment, specifically, the voltage holding circuit 10 includes a first energy storage circuit 11 and a voltage conversion circuit 12.

Wherein, the voltage holding circuit 10 in this application is used in power devices that require power-outage holding or low-voltage input compensation in power supply to a load. For example, in case of power outage of a storage medium, in order to avoid irreversible losses such as data loss caused by cache failure, the voltage holding circuit 10 will hold the power output to the storage medium for a certain period. Of course, in other embodiments, the voltage holding circuit 10 may also be used in intelligent terminal devices, UAVs, electric toys or any other reasonable electronic and mechanical devices with the need of power-outage holding or low-voltage input compensation. This embodiment is not intended to limit these devices.

In some embodiments, the voltage conversion circuit 12 is coupled between the first energy storage circuit 11 and a second energy storage circuit 101 to receive the input voltage from the second energy storage circuit 101, and realizes corresponding conversion and regulation of voltage between the first energy storage circuit 11 and the second energy storage circuit 101.

Wherein, the second energy storage circuit 101 is also coupled with an external power source to obtain power and receive the input voltage from the power source.

It is worth noting that specifically, the power source can be understood as a grid power source, or the power output after power conversion and regulation of grid power source; and specifically, the second energy storage circuit 101 may be understood as an electrical load or a power storage circuit connected to an external load power circuit.

Furthermore, the term “coupling” in this application refers to any direct and indirect means of connection. Therefore, the description that the first circuit is coupled with the second circuit in the application means that the first circuit may be directly connected to the second circuit by electrical connection or signal connection such as wireless transmission and optical transmission, or indirectly connected to the second circuit through other circuits or connection means by electrical connection or signal connection.

Further, when it is confirmed that the input voltage is within the first threshold range, the voltage conversion circuit 12 boosts and outputs the input voltage to the first energy storage circuit 11 to store boosted voltage into the first energy storage circuit 11 and obtain the first energy storage voltage.

Wherein, when it is confirmed that the input voltage is lower than the first threshold range and/or the drop rate of input voltage is within the preset threshold range, i.e., the input voltage drops and the drop magnitude and/or rate exceed the preset allowable value, the voltage conversion circuit 12 outputs the first energy storage voltage of the first energy storage circuit 11 to the second energy storage circuit 101 so as to store the current first energy storage voltage into the second energy storage circuit 101 and superimpose with the second energy storage voltage of the second energy storage circuit 101 with a view to extending the hold-up time of the second energy storage voltage of the second energy storage circuit 101 within the first threshold range until the first energy storage voltage of the first energy storage circuit 11 and current energy storage voltage of the second energy storage circuit 101 are consumed to voltage below critical holding value. The second energy storage circuit 101 can complete necessary work in a timely manner within the hold-up time of the second energy storage voltage.

It is worth noting that specifically, the first threshold range may be understood as a voltage range of holding normal work of the second energy storage circuit 101 or an external load connected to the second energy storage circuit 101, such as the input capacitor, or a power output range of holding the normal work of a storage chip, a signal processing chip or a MCU circuit, and may be any reasonable threshold range such as 25V-36V, 36V-50V, or 50V-70V It may be determined based on a practical application scenario. However, the present disclosure is not limited to the embodiments described herein.

Furthermore, the preset threshold range may be understood as any reasonable range of drop rate of voltage that cannot hold a normal working trend of the second energy storage circuit 101 or an external load connected to the second energy storage circuit 101 when the drop rate of the input voltage is within the preset threshold range. It may be determined based on a practical application scenario. However, the present disclosure is not limited to the embodiments described herein.

In above scheme, when the input voltage is lower than the first threshold range and/or the drop rate of the input voltage is within the preset threshold range, the first energy storage voltage of the first energy storage circuit 11 is outputted to the second energy storage circuit 101 to effectively extend the hold-up time of the second energy storage voltage of the second energy storage circuit 101 within the first threshold range. Therefore, this scheme can effectively realize power-outage holding or low-voltage input compensation without installing additional energy storage components or increasing the energy storage voltage during discharge. It can also respond to the drop of the input voltage and/or the drop trend of the input voltage to quickly boost the voltage of the second energy storage circuit with low cost and small size. It is convenient for smaller sizes and lower costs. In addition, a voltage conversion circuit 12 for both boosting and bucking can realize the voltage bidirectional conversion, effectively save circuit components and reduce the size of energy storage components with a view to effectively simplifying the circuit control. Besides, compared with outputting the first energy storage voltage to the second energy storage circuit 101 in responding to that the input voltage is lower than the first threshold range, the first energy storage voltage is more quickly outputted to the second energy storage circuit 101 in responding to that the drop rate of the input voltage is within the preset threshold range. In addition, when the input voltage is still not lower than the first threshold range, i.e., there is a certain drop trend, the output starts to effectively avoid adverse effects on the operation of the second energy storage circuit 101 during the power-outage holding phase when the input voltage is lower than the first threshold range.

In an embodiment, when it is confirmed that the first energy storage voltage of the first energy storage circuit 11 is within the second threshold range, the voltage conversion circuit 12 stops boosting and outputting to the first energy storage circuit 11, i.e., disconnect the connection between the first energy storage circuit 11 and the second energy storage circuit 101, to try to reduce the power loss of the voltage conversion circuit 12 and the first energy storage circuit 11 when the second energy storage circuit 101 works normally with the input voltage from the power source or the second energy storage circuit 101 utilizes the input voltage to supply power to an external load to drive the normal work of the load. Compared with traditional boost circuits, i.e., those boost circuits in continuous operation, the embodiments in this application have lower requirements for specifications of components in the voltage conversion circuit 12 and realize smaller size and lower cost of circuits without influence of voltage stress of normal power circuits.

Further, because it is inevitable that there will be some power loss in the voltage conversion circuit 12 and the first energy storage circuit 11, the first energy storage voltage of the first energy storage circuit 11 slowly drops. When it is confirmed that the first energy storage voltage of the first energy storage circuit 11 is lower than the second threshold range, the voltage conversion circuit 12 boosts the input voltage again and outputs it to the first energy storage circuit 11, and the first energy storage voltage of the first energy storage circuit 11 is boosted to the voltage within the second threshold range with a view to holding the first energy storage voltage within the allowable design range.

It is worth noting that, the second threshold range may be understood as a reasonable voltage range in which the first energy storage circuit 11 can utilize the first energy storage voltage of the first energy storage circuit 11 to boost the second energy storage voltage to the voltage within the first threshold range again when the second energy storage voltage of the second energy storage circuit 101 is lower than the first threshold range. It may be determined based on a practical application scenario. However, the present disclosure is not limited to the embodiments described herein.

In an embodiment, when the second energy storage voltage of the second energy storage circuit 101 is lower than the first threshold range, specifically, the first energy storage voltage of the first energy storage circuit 11 may be bucked and outputted to the second energy storage circuit 101 to store the first energy storage voltage into the second energy storage circuit 101 after being bucked and to superpose with the current energy storage voltage of the second energy storage circuit 101 to boost the second energy storage voltage of the second energy storage circuit 101 to the value within the first threshold range.

In other embodiments, when the second threshold range for the first energy storage voltage is not higher than the normal input voltage, i.e., within the voltage range of holding normal work of the second energy storage circuit 101 or an external load connected to the second energy storage circuit 101, the first energy storage voltage may be directly outputted to the second energy storage circuit 101 without bucking. For example, when the first threshold range for the normal input voltage of the power source is 40-72V and when the input voltage is 40V, if the voltage conversion circuit 12 boosts the first energy storage voltage of the first energy storage circuit to 72V or slightly lower than 72V, the first energy storage voltage may be directly discharged to the second energy storage circuit when the input voltage is lower than 40V. When the voltage conversion circuit 12 boosts the first energy storage voltage to value higher than 72V, the first energy storage voltage shall be bucked and outputted to the second energy storage circuit 101 when the input voltage is lower than 40V.

It can be understood that the second threshold range may also be within the voltage range of holding normal work of the second energy storage circuit 101 or an external load connected to the second energy storage circuit 101 so that the voltage conversion circuit 12 may output the first energy storage voltage of the first energy storage circuit 11 to the second energy storage circuit 101 without bucking, i.e., the voltage conversion circuit 12 may avoid or be omitted with a view to saving corresponding buck circuit configuration and buck control.

In some embodiments, the lower voltage limit of the second threshold range is higher than the upper voltage limit of the first threshold range, i.e., the voltage within the second threshold range is greater than the voltage within the first threshold range; or, the lower voltage limit of the second threshold range is lower than the upper voltage limit of the first threshold range, and the upper voltage limit of the second threshold range is higher than the upper voltage limit of the first threshold range, i.e., the second threshold range may partially overlap with the first threshold range, but at least, the voltage within a portion of the second threshold range is higher than any voltage within the first threshold range, and it may be any reasonable threshold range such as 50V-80V, 70V-90V or 100V-120V It may be determined based on a practical application scenario. However, the present disclosure is not limited to the embodiments described herein.

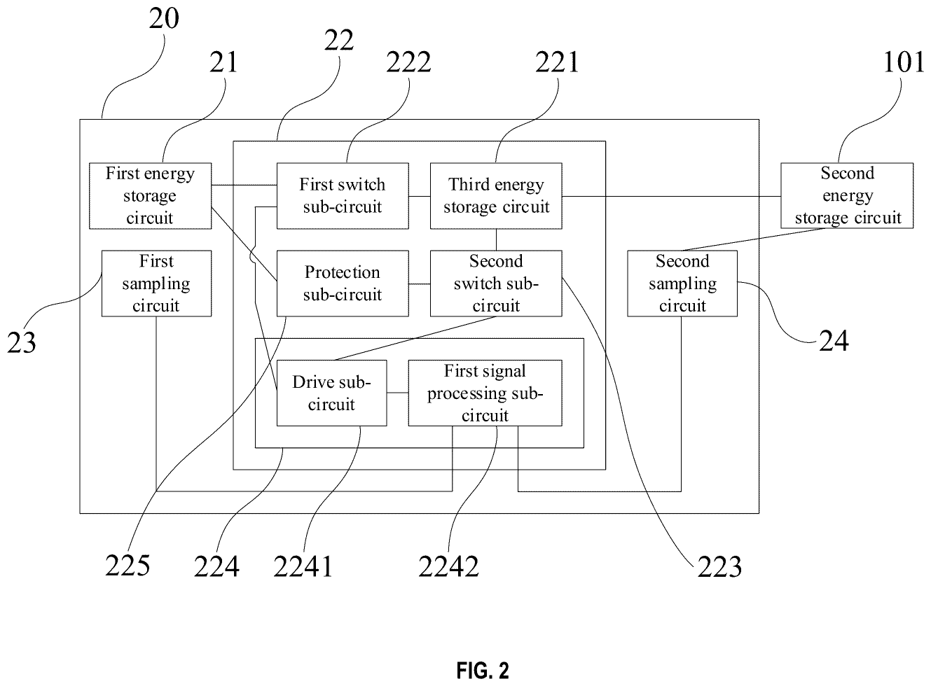

Referring to FIG. 2, FIG. 2 illustrates a structural schematic diagram of the second embodiment of the voltage holding circuit in this application. A difference between the voltage holding circuit in this embodiment and the first embodiment of the voltage holding circuit in this application is that a voltage conversion circuit 22 of the voltage holding circuit 20 in this embodiment further includes a third energy storage circuit 221, a first switch sub-circuit 222, a second switch sub-circuit 223 and a control circuit 224.

The third energy storage circuit 221 is coupled with the second energy storage circuit 101, the first switch sub-circuit 222 and the second switch sub-circuit 223, the first switch sub-circuit 222 is coupled with the second switch sub-circuit 223, the first energy storage circuit 21 and the control circuit 224, the second switch sub-circuit 223 is coupled with the control circuit 224, and the control circuit 224 is coupled with a second energy storage circuit 101.

Wherein, the third energy storage circuit 221 receives the input voltage from the second energy storage circuit 101 to store the input voltage into the third energy storage circuit 221.

The control circuit 224 obtains the input voltage from the second energy storage circuit 101 by sampling, triggers the second switch sub-circuit 223 ON at a set interval, superposes the third energy storage voltage of the third energy storage circuit 221 with the input voltage, and stores them into the first energy storage circuit 21 when the input voltage is within the first threshold range, i.e., the second switch sub-circuit 223 which is ON at an interval and the third energy storage circuit 221 are combined to form a boost (boost chopper) circuit to boost and output the input voltage to the first energy storage circuit 21.

It is worth noting that when the control circuit 224 triggers the second switch sub-circuit 223 ON, it may trigger the first switch sub-circuit 222 ON to boost and output the input voltage to the first energy storage circuit 21 through the first switch sub-circuit 222 and trigger the first switch sub-circuit 222 OFF to boost and output the input voltage to the first energy storage circuit 21 through the internal path formed by semiconductor characteristics of the first switch sub-circuit 222, such as an electric path formed by body diode in the first switch sub-circuit 222. In some embodiments, to simplify the control mode of the control circuit 224, the control circuit 224 may realize the ON-OFF control of the second switch sub-circuit 223 and the first switch sub-circuit 222 by two synchronous pulse width modulation (PWM) control signals in opposite phases so as to boost and output the input voltage to the first energy storage circuit 21. However, the present disclosure is not limited to the embodiments described herein.

Furthermore, the set interval may be a half cycle of PWM control signal for the second switch sub-circuit 223 and also may be an interval set in the program. It may be determined based on a practical application scenario. However, the present disclosure is not limited to the embodiments described herein.

Further, the control circuit 224 triggers the first switch sub-circuit 222 ON and triggers the second switch sub-circuit 223 OFF when the input voltage from the second energy storage circuit 101 is lower than the first threshold range, and/or the drop rate of the input voltage is within the preset threshold range, outputs the first energy storage voltage to the second energy storage circuit 101, and boosts the second energy storage voltage of the second energy storage circuit 101 to the value within the first threshold again so that the second energy storage voltage of the second energy storage circuit 101 can be held for a certain period within the first threshold range to complete the necessary work during holding the voltage.

It is worth noting that when it is necessary to regulate the hold-up time of the second energy storage voltage within the first threshold range in a power off state of the power source, just regulate the control signal wave form for controlling the second switch sub-circuit 223 ON/OFF and the voltage control of the first energy storage circuit 21. The regulation is simple and convenient.

In some embodiments, the control circuit 224 may include any of reasonable circuit units with program and signal processing functions, such as a control chip, a MCU circuit, a CPU, a single-chip computer, a field programmable gate array, a programmable logic controller, a discrete gate or a transistor logic device and a piece of discrete hardware. However, the present disclosure is not limited to the embodiments described herein.

In an embodiment, the voltage conversion circuit 22 also includes a protection sub-circuit 225 coupled between the second switch sub-circuit 223 and the first energy storage circuit 21 to limit the current between the second switch sub-circuit 223 and the first energy storage circuit 21 within a third threshold range with a view to avoiding damages caused by possible surge current to the second switch sub-circuit 223.

In some embodiments, the protection sub-circuit 225 may include a circuit unit composed of any reasonable components, such as a resistor/adjustable resistor, a resistor/Zener diode D1, and/or a surge protection device. It may be determined based on a practical application scenario. However, the present disclosure is not limited to the embodiments described herein.

It can be understood that the protection sub-circuit 225 is coupled between the second switch sub-circuit 223 and the first energy storage circuit 21 to lock the wave when the current of the protection sub-circuit 225 reaches a certain value with a view to effectively ensuring safety of the voltage holding circuit 20.

It is worth noting that the wave lock control is a common control technology in electronic systems to limit the signal frequency range with a view to preventing unnecessary spectrum expansion and interference. In the fields of communication and electronic devices, the main purpose of wave lock control is to ensure the transmission of signals within a specific frequency range and prevent the spectral distribution of signals from exceeding the specified range. Wave lock control is conducive to avoiding frequency conflicts between the signals and other communication signals or radio devices, reducing interference and improving the reliability and performance of the system.

In an embodiment, the voltage conversion circuit 22 also further includes a first sampling circuit 23 coupled with the first energy storage circuit 21 and the control circuit 224 to obtain the first energy storage voltage by sampling and send the first energy storage voltage to the control circuit 224, and the control circuit 224 realizes ON/OFF control through the first switch sub-circuit 222 and/or the second switch sub-circuit 223 based on the first energy storage voltage.

In an embodiment, the voltage conversion circuit 22 also further includes a second sampling circuit 24 coupled with the second energy storage circuit 101 and the control circuit 224 to obtain the input voltage from the second energy storage circuit 101 by sampling or directly obtain the second energy storage voltage of the second energy storage circuit 101 to avoid misjudgment caused by fluctuations in input voltage, and send the input voltage to the control circuit 224; the control circuit 224 realizes ON/OFF control of the first switch sub-circuit 222 and/or the second switch sub-circuit 223 based on the input voltage.

In some embodiments, the first sampling circuit 23 also includes a resistor, two equivalent resistors, or two adjustable resistors, or other circuit units composed of any reasonable components such as resistors and adjustable resistors to realize the voltage sampling by parallel connection of resistors and to use the resistance voltage division sampling. It may be determined based on a practical application scenario. However, the present disclosure is not limited to the embodiments described herein.

In an embodiment, the control circuit 224 also further includes a first signal processing sub-circuit 2242 and a drive sub-circuit 2241; the first signal processing sub-circuit 2242 is coupled with the second sampling circuit 24 and the drive sub-circuit 2241, and the drive sub-circuit 2241 is coupled with the first switch sub-circuit 222 and the second switch sub-circuit 223; the first signal processing sub-circuit 2242 receives the input voltage from the second sampling circuit 24, generates a second control signal based on the input voltage, and sends the second control signal to the drive sub-circuit 2241; the drive sub-circuit 2241 responds to the second control signal and sends the second drive signal to the second switch sub-circuit 223 to trigger the second switch sub-circuit 223 ON or OFF, boost and output the input voltage to the first energy storage circuit 21 by ON/OFF control of the second switch sub-circuit 223; the first energy storage circuit 21 stores energy to provide the power output to the second energy storage circuit 101 in power outage.

Further, in an embodiment, the first signal processing sub-circuit 2242 is also coupled with the first sampling circuit 23; the first signal processing sub-circuit 2242 receives the first energy storage voltage from the first sampling circuit 23, generates a first control signal based on the first energy storage voltage and sends the first control signal to the drive sub-circuit 2241; the drive sub-circuit 2241 responds to the first control signal and sends a first drive signal to the first switch sub-circuit 222 to trigger the first switch sub-circuit 222 ON or OFF.

Wherein, the first drive signal and the second drive signal are both PWM control signals; specifically, the second drive signal may be corresponding to that when the input voltage is within the first threshold range, trigger the second switch sub-circuit 223 ON at a set interval and the first drive signal triggers the first switch sub-circuit 222 ON or OFF; the second switch sub-circuit 223 boosts and outputs the input voltage to the first energy storage circuit 21 by ON/OFF control to store energy in the first energy storage circuit 21 and provides the power output to the second energy storage circuit 101 in power outage.

And, in some embodiments, the second drive signal triggers the second switch sub-circuit 223 OFF and the first drive signal triggers the first switch sub-circuit 222 ON when the input voltage is lower than the first threshold range, and/or the drop rate of the input voltage is within the preset threshold range, and the second energy storage voltage of the second energy storage circuit 101 may be boosted to the value within the first threshold range by synchronous ON/OFF control of the first switch sub-circuit 222 and the second switch sub-circuit 223; the second energy storage voltage of the second energy storage circuit 101 can be effectively held for a certain period within the first threshold range to complete the necessary work during holding voltage when the power sources fails to provide the input voltage.

In some embodiments, the first signal processing sub-circuit 2242 may be any of reasonable circuit units with digital signal processing functions or digital and analog signal processing functions, such as a DSP chip or a digital analog processing circuit. However, the present disclosure is not limited to the embodiments described herein.

In some embodiments, the drive sub-circuit 2241 may be any of reasonable circuit units with program and signal processing functions, such as a control chip, a MCU circuit, a CPU, a single-chip computer, a field programmable gate array, a programmable logic controller, a discrete gate or a transistor logic device and a piece of discrete hardware. However, the present disclosure is not limited to the embodiments described herein.

It can be understood that, the voltage holding circuit 20 may adopt digital control or mixed analog-digital control by utilizing the first signal processing sub-circuit 2242 and the drive sub-circuit 2241; in some embodiments, the first signal processing sub-circuit 2242 may calculate and process the sampling signals to respond to a PWM control signal generated when the input voltage from the second energy storage circuit 101 is within the first threshold range, or the input voltage is lower than the first threshold range, and/or the drop rate of the input voltage is within the preset threshold range, and reasonably regulate the duty cycle and/or frequency of the PWM control signal based on the input voltage; the drive sub-circuit 2241 converts the control signal into a corresponding drive signal, and realizes ON/OFF control of the first switch sub-circuit 222 and the second switch sub-circuit 223 by utilizing this drive signal, i.e., the signal processing operation for ON/OFF control can be carried out by the first signal processing sub-circuit 2242; by ON/OFF control of the first switch sub-circuit 222 and the second switch sub-circuit 223, store energy in the first energy storage circuit 21; the energy stored in the first energy storage circuit 21 can be used to realize power-outage holding or low-voltage input compensation for the second energy storage circuit 101.

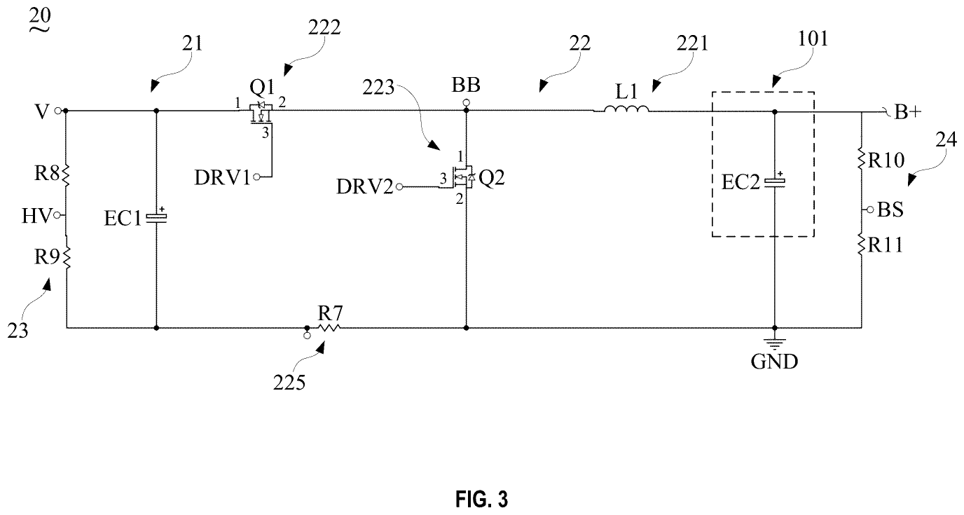

Referring to FIG. 3, FIG. 3 illustrates a structural schematic diagram of an embodiment of a part of the voltage holding circuit in FIG. 2.

In an embodiment, the first energy storage circuit 21 also includes a storage capacitor EC1, the second energy storage circuit 101 includes an input capacitor EC2, the third energy storage circuit 221 includes a first inductor L1, the first switch sub-circuit 222 includes a first switching tube Q1 and the second switch sub-circuit 223 includes a second switching tube Q2.

Wherein, the first end of the input capacitor EC2 is coupled with the second energy storage circuit 101 and the first end of the first inductor L1, the second end of the first inductor L1 is coupled with the second end of the first switching tube Q1 and the first end of the second switching tube Q2, the first end of the first switching tube Q1 is coupled with the first end of the storage capacitor EC1, the second end of the input capacitor EC2 is coupled with the second end of the second switching tube Q2 and the second end of the storage capacitor EC1 and is grounded, the third end of the first switching tube Q1 is coupled with the first end of the control circuit 224, and the third end of the second switching tube Q2 is coupled with the second end of the control circuit 224.

Further, in an embodiment, the protection sub-circuit 225 includes a seventh resistor R7; the first end of the seventh resistor R7 is coupled with the second end of the second switching tube Q2 and the second end of the input capacitor EC2 and is grounded, and the second end of the seventh resistor R7 is coupled with the second end of the storage capacitor EC1; or, the first end of the seventh resistor R7 is coupled with the second end of the second switching tube Q2, the second end of the seventh resistor R7 is coupled with the second end of the input capacitor EC2 and the second end of the storage capacitor EC1, and is grounded.

Further, in an embodiment, the first sampling circuit 23 includes an eighth resistor R8 and a ninth resistor R9, and the second sampling circuit 24 includes a tenth resistor R10 and an eleventh resistor R11; the first end of the eighth resistor is coupled with the first end of the first switching tube Q1 and the first end of the storage capacitor EC1, the second end of the eighth resistor R8 is coupled with the first end of the ninth resistor R9, the second end of the ninth resistor R9 is coupled with the second end of the storage capacitor EC1 and the second end of the seventh resistor R7, the first end of the tenth resistor R10 is coupled with the second energy storage circuit 101, the first end of the input capacitor EC2 and the first end of the first inductor L1, the second end of the tenth resistor R10 is coupled with the first end of the eleventh resistor R11, and the second end of the eleventh resistor R11 is coupled with the second end of the input capacitor EC2, the second end of the second switching tube Q2 and the first end of the seventh resistor R7, and is grounded.

In other embodiments, the seventh resistor R7 may be omitted, i.e., short circuit of the seventh resistor R7. However, the present disclosure is not limited to the embodiments described herein.

It can be understood that, the control circuit 224 may detect the voltage of a first sampling node HV and a second sampling node BS, and respond to the sampling results to send a first drive signal to the first switching tube Q1 and a second drive signal to the second switching tube Q2 to trigger the first switching tube Q1 ON or OFF under the action of the first drive signal and to trigger the second switching tube Q2 ON or OFF under the action of the second drive signal; through ON/OFF control of the first switching tube Q1 and the second switching tube Q2, when the input voltage from the second energy storage circuit 101 is within the first threshold range, the energy stored in the first inductor L1 and the input voltage are superposed, boosted and outputted to the storage capacitor EC1 for storage; when the input voltage is lower than the first threshold range, and/or the drop rate of the input voltage is within the preset threshold range, energy stored in the storage capacitor EC1 is outputted to the input capacitor EC2 so as to boost the second energy storage voltage of both ends of the storage capacitor EC1 to the value within the first threshold range, effectively realizing the power-outage holding or low-voltage input compensation.

In some embodiments, the first switching tube Q1 and the second switching tube Q2 may be a MOS tube, a triode, a thin-film transistor, a field-effect transistor or one of any other reasonable switching tubes. However, the present disclosure is not limited to the embodiments described herein.

It is worth noting that to distinguish the two ends of the above switching tubes except for the control end, one pole is called the first end and the other pole is called the second end. If the switching tube is a triode, specifically, the control end, i.e., the third end, may be a base pole, the first end may be a collector and the second end may be an emitter; or, specifically, the third end may be a base pole, the first end may be an emitter and the second end may be a collector.

If the switching tube is a MOS tube, a thin-film transistor or a field-effect transistor, specifically, the third end may be a grid, the first end may be a drain, and the second end may be a source; or, specifically, the third end may be a grid, the first end may be a source and the second end may be a drain.

Wherein, if the switching tube is a MOS tube, a thin-film transistor or a field-effect transistor, specifically, the switching tube may be a composite transistor or a monolithic transistor. However, the present disclosure is not limited to the embodiments described herein.

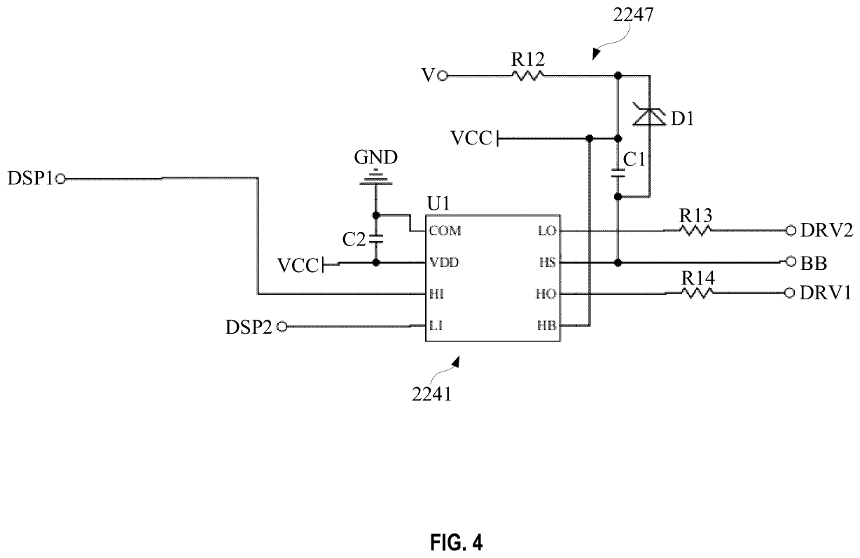

Referring to FIG. 4, FIG. 4 illustrates a structural schematic diagram of an embodiment of the voltage conversion circuit 22 of the voltage holding circuit 20 in FIG. 2.

In an embodiment, the voltage conversion circuit 22 also includes a peripheral circuit 2247 which is coupled with the drive sub-circuit 2241 and the first switch sub-circuit 222; when the control circuit 224 sends a first drive signal to the first switch sub-circuit 222, a proper voltage difference forms between both ends of the first switch sub-circuit 222 to help the first drive signal to trigger the first switch sub-circuit 222 ON.

In some embodiments, the peripheral circuit 2247 includes a first capacitor C1, a Zener diode D1 and a twelfth resistor R12; the first end of the first capacitor C1 is coupled with the third end of the control circuit 224, the second end of the first switching tube Q1, the first end of the second switching tube Q2, the second end of the first inductor L1 and the first end of the Zener diode D1, the second end of the first capacitor C1 is coupled with the fourth end of the control circuit 224, the second end of the Zener diode D1, the first end of the twelfth resistor R12 and the set level supply end VCC, and the second end of the twelfth resistor R12 is coupled with the first end of the first switching tube and the first end of the storage capacitor EC1.

From this, the peripheral circuit 2247 may be understood as parallel connection with the first end BB and the second end V of the first switching tube Q1; when the first switching tube Q1 receives a first drive signal from the control circuit 224, a proper voltage difference may form between the first end and the second end of the first switching tube Q1 to ensure to effectively trigger the first switching tube Q1 ON or OFF.

Further, in an embodiment, the control circuit 224 also includes the first signal processing sub-circuit 2242 and the drive sub-circuit 2241; the drive sub-circuit 2241 further includes a driver U1, a second capacitor C2, a thirteenth resistor R13 and a fourteenth resistor R14; the fifth end H1 of the driver U1 is coupled with the first end DSP1 of the first signal processing sub-circuit 2242 to receive the first control signal from the first signal processing sub-circuit 2242; the first end HO of the driver U1 is coupled with the first end of the fourteenth resistor R14, and the second end of the fourteenth resistor R1 is coupled with the third end of the first switching tube Q1 to send a first drive signal to the third end of the first switching tube Q1 through the fourteenth resistor R1 based on the first control signal with a view to realizing the ON/OFF control of the first switching tube Q1; the sixth end L1 of the driver U1 is coupled with the second end DSP2 of the first signal processing sub-circuit 2242 to receive the second control signal from the first signal processing sub-circuit 2242, the second end LO of the driver U1 is coupled with the first end of the thirteenth resistor R13, and the second end of the thirteenth resistor R13 is coupled with the third end of the second switching tube Q2 to send the second drive signal to the third end of the second switching tube Q2 through the thirteenth resistor R13 based on the second control signal with a view to realizing the ON/OFF control of the second switching tube Q2.

Wherein, the third end HS of the driver U1 is coupled with the first end of the first capacitor C1, the second end of the first switching tube Q1, the first end of the second switching tube Q2, the second end of the first inductor L1 and the first end of the Zener diode D1; the fourth end HB of the driver U1 is coupled with the second end of the first capacitor C1, the second end of the Zener diode D1, the first end of the twelfth resistor R12 and the set level supply end VCC; the seventh end VDD of the driver U1 is coupled with the set level supply end VCC and the first end of the second capacitor C2; the eighth end COM of the driver U1 is coupled with the second end of the second capacitor C2 and is grounded.

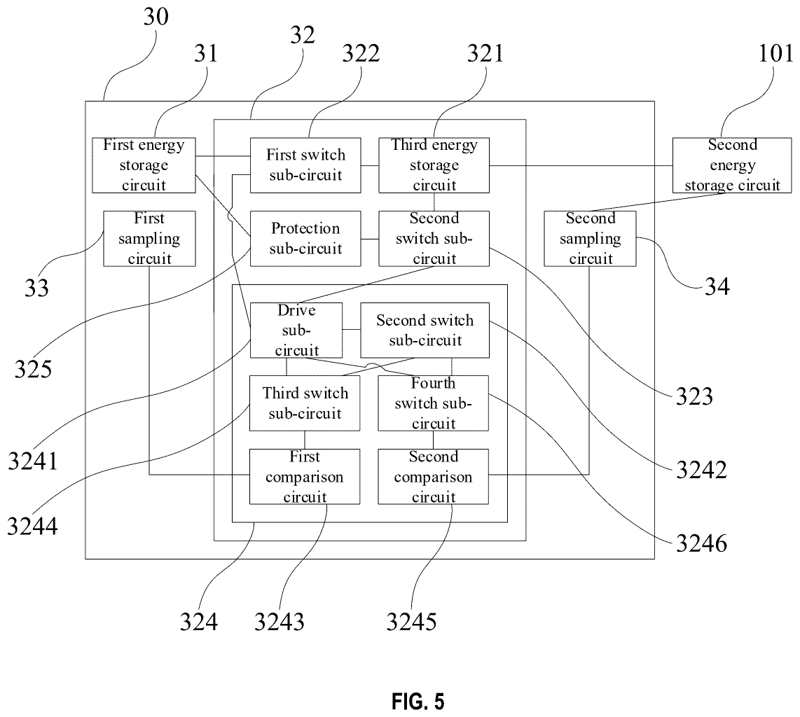

Referring to FIG. 5, FIG. 5 illustrates a structural schematic diagram of the third embodiment of the voltage holding circuit in this application. The difference between a voltage holding circuit in this embodiment and the second embodiment of the voltage holding circuit in this application is that, the control circuit 324 of the voltage conversion circuit 32 of the voltage holding circuit 30 also includes a second signal processing sub-circuit 3242, a first comparison circuit 3243, a third switch sub-circuit 3244 and a drive sub-circuit 3241.

In some embodiments, the second signal processing sub-circuit 3242 is coupled with the third switch sub-circuit 3244 and the drive sub-circuit 3241 and the first comparison circuit 3243 is coupled with the second sampling circuit 34 and the third switch sub-circuit 3244; the first comparison circuit 3243 receives the input voltage from the second sampling circuit 34, compares the input voltage with a first reference voltage, obtains a first comparison signal and sends the first comparison signal to the third switch sub-circuit 3244 to trigger the third switch sub-circuit 3244 ON or OFF; the second signal processing sub-circuit 3242 sends a third control signal to the drive sub-circuit 3241 when the third switch sub-circuit 3244 is OFF, and the drive sub-circuit 3241 sends a third drive signal to the second switch sub-circuit 323 under the action of the third control signal to trigger the second switch sub-circuit 323 ON or OFF, realizing corresponding energy storage, power-outage holding or low-voltage input compensation.

It is worth noting that, the first reference voltage may be the lower limit of the first threshold range so that the first comparison circuit 3243 can effectively confirm whether the input voltage is within or lower than the first threshold range when comparing the obtained input voltage and the first reference voltage; when the input voltage is higher than the first reference voltage, i.e., the input voltage is within the first threshold range, the first comparison circuit 3243 outputs a first comparison signal 1 to trigger the third switch sub-circuit 3244 ON; the second signal processing sub-circuit 3242 is grounded through the third switch sub-circuit 3244 and doesn't send the third control signal to the drive sub-circuit 3241; when the input voltage is lower than the first reference voltage, i.e., the input voltage is lower than the first threshold range, the first comparison circuit 3243 outputs the first comparison signal 0 to trigger the third switch sub-circuit 3244 OFF, and the second signal processing sub-circuit 3242 sends the third control signal to the drive sub-circuit 3241.

In some embodiments, the first reference voltage may be within any reasonable threshold range, such as 25V, 36V, 50V, etc. It may be determined based on a practical application scenario. However, the present disclosure is not limited to the embodiments described herein.

In an embodiment, the control circuit 324 also includes a second comparison circuit 3245 and a fourth switch sub-circuit 3246; the second comparison circuit 3245 is coupled with the first sampling circuit 33, the fourth switch sub-circuit 3246 and the second signal processing sub-circuit 3242; the second comparison circuit 3245 receives the first energy storage voltage from the first sampling circuit 33, compares the first energy storage voltage with a second reference voltage, obtains a second comparison signal and sends the second comparison signal to the fourth switch sub-circuit 3246 to trigger the fourth switch sub-circuit 3246 ON or OFF; the second signal processing sub-circuit 3242 sends a fourth control signal to the drive sub-circuit 3241 when the fourth switch sub-circuit 3246 is OFF and the drive sub-circuit 3241 sends a fourth drive signal to the first switch sub-circuit 322 under the action of the fourth control signal to trigger the first switch sub-circuit 322 ON or OFF with a view to coordinating to control of the second switch sub-circuit 323 ON or OFF to realize corresponding energy storage, power-outage holding or low-voltage input compensation.

It is worth noting that, the second reference voltage may be a lower limit of the second threshold range, so that the second comparison circuit 3245 can effectively confirm whether the first energy storage voltage is within or lower than the second threshold range when comparing the obtained first energy storage voltage with the second reference voltage; when the first energy storage voltage is higher than the second reference voltage, i.e., the first energy storage voltage is within the second threshold range, the second comparison circuit 3245 outputs the second comparison signal 1 to trigger the fourth switch sub-circuit 3246 ON; the second signal processing sub-circuit 3242 is grounded through the fourth switch sub-circuit 3246 and doesn't send a fourth control signal to the drive sub-circuit 3241; when the first energy storage voltage is lower than the second reference voltage, i.e., the first energy storage voltage is lower than the second threshold range, the second comparison circuit 3245 outputs the second comparison signal 0 to trigger the fourth switch sub-circuit 3246 OFF, and the second signal processing sub-circuit 3242 sends a fourth control signal to the drive sub-circuit 3241.

In some embodiments, the second reference voltage may be within any reasonable threshold range, such as 50V, 70V, 100V, etc. It may be determined based on a practical application scenario. However, the present disclosure is not limited to the embodiments described herein.

It can be understood that, the voltage holding circuit 30 may utilize the second signal processing sub-circuit 3242, the first comparison circuit 3243, the second comparison circuit 3245 and the drive sub-circuit 3241 to realize simulation control; in some embodiments, the first comparison circuit 3243 and the second comparison circuit 3245 may replace the second signal processing sub-circuit 3242 for computation processing of a sampling signal by voltage comparison to respond to that the input voltage from the second energy storage circuit 101 is within the first threshold range, or the input voltage is lower than the first threshold range; the output ON/OFF regulation can be carried out for the third control signal and the fourth control signal of the drive sub-circuit 3241 from the second signal processing sub-circuit 3242 by controlling the third switch sub-circuit 3244 and the fourth switch sub-circuit 3246 ON or OFF; the drive sub-circuit 3241 converts the third control signal and the fourth control signal to corresponding third drive signal and fourth drive signal to realize the ON/OFF control of the second switch sub-circuit 323 and the first switch sub-circuit 322; the energy in the first energy storage circuit 31 can be stored by ON/OFF control of the first switch sub-circuit 322 and the second switch sub-circuit 323, and energy stored in the first energy storage circuit 31 realizes power-outage holding or low-voltage input compensation for the second energy storage circuit 101.

From this, the third control signal and the fourth control signal from the second signal processing sub-circuit 3242 to the drive sub-circuit 3241 may be PWM control signals with fixed frequency and fixed duty cycle to save the digital operation processing of the second signal processing sub-circuit 3242; however, the actual signal operation processing can also be carried out by the first comparison circuit 3243 and the second comparison circuit 3245; the output ON/OFF regulation of the third control signal and the fourth control signal can effectively chop waves of the third control signal and the fourth control signal to regulate the duty cycle and/or frequency to respond to the obtained input voltage and/or the first energy storage voltage; the ON/OFF state of the first switch sub-circuit 322 and the second switch sub-circuit 323 can be regulated by regulating the duty cycle and/or frequency of the control signal to realize effective energy storage, and/or power-outage holding or low-voltage input compensation.

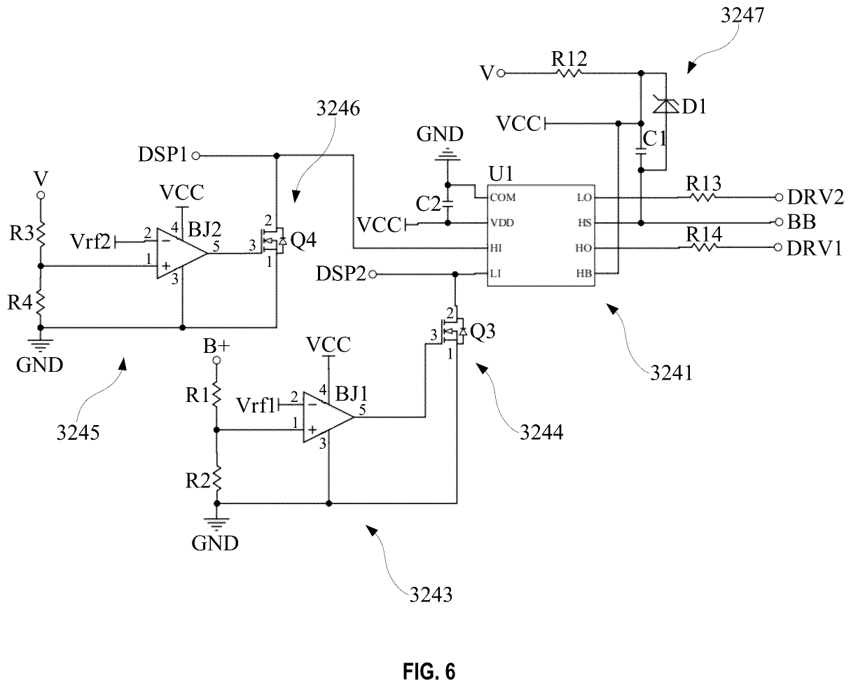

Referring to FIG. 6, FIG. 6 illustrates a structural schematic diagram of an embodiment of the voltage conversion circuit of the voltage holding circuit in FIG. 5.

In an embodiment, the first comparison circuit 3243 further includes a first resistor R1, a second resistor R2 and a first comparator BJ1 and the third switch sub-circuit 3244 includes a third switching tube Q3; the first end of the first resistor R1 is coupled with the first end of the first energy storage circuit 31, the second end of the first resistor R1 is coupled with the first end of the second resistor R2 and the first end of the first comparator BJ1, the second end of the second resistor R2 is coupled with the third end of the first comparator BJ1, the first end of the third switching tube Q3 and is grounded, the second end of the first comparator BJ1 is coupled with the first reference voltage supply end Vrf1, the fourth end of the first comparator BJ1 is coupled with the set level supply end VCC, the fifth end of the first comparator BJ1 is coupled with the third end of the third switching tube Q3, and the second end of the third switching tube Q3 is coupled with the first end of the second signal processing sub-circuit 3242 and the first end of the drive sub-circuit 3241.

It can be understood that, the first comparator BJ1 samples at the input end of the second energy storage circuit 101 by utilizing the first resistor R1 and the second resistor R2 to obtain the input voltage from the second energy storage circuit 101 and compares the input voltage with the first reference voltage to control the third switching tube Q3 ON or OFF so as to control the third control signal of the drive sub-circuit 3241 from the second signal processing sub-circuit 3242, i.e., control the second signal processing sub-circuit 3242 to send or not to send the third control signal to the drive sub-circuit 3241. The corresponding control process is described in the relevant text of FIG. 5. No more description is made herein.

Further, in an embodiment, the first comparison circuit 3243 also includes a fifth resistor (not marked on the figure); the first end of the fifth resistor is coupled with the first end of the first comparator BJ1, and the second end of the fifth resistor is coupled with the fifth end of the first comparator BJ1; the fifth resistor may adjust the comparison of the input voltage with the first reference voltage into the comparison of the input voltage with the third threshold range, send a first comparison signal 1 in case of higher than the third threshold range, and send a first comparison signal 0 in case of lower than the third threshold range to avoid frequent comparison by the first comparator BJ1 caused by unstable electrical signals and interference signals, in which the corresponding ON/OFF control is not stable, affecting the stability of the whole work of the voltage holding circuit 30.

It is worth noting that, as for the third threshold range, the lower limit is the difference between the first reference voltage and the first stepped voltage, while the upper limit is the sum of the first reference voltage and the first stepped voltage.

Furthermore, the first stepped voltage may be determined based on the resistance of the fifth resistor, i.e., regulate the resistance of the fifth resistor to effectively regulate the first stepped voltage so as to adjust the comparison state of the first comparator BJ1 to adapt to practical application scenarios. However, the present disclosure is not limited to the embodiments described herein.

In an embodiment, the second comparison circuit 3245 further includes a third resistor R3, a fourth resistor R4 and a second comparator BJ2 and the fourth switch sub-circuit 3246 includes a fourth switching tube Q4; the first end of the third resistor R3 is coupled with the first end of the second energy storage circuit 101, the second end of the third resistor R3 is coupled with the first end of the fourth resistor R4 and the first end of the second comparator BJ2, the second end of the fourth resistor R4 is coupled with the third end of the second comparator BJ2 and the first end of the fourth switching tube Q4 and is grounded, the second end of the second comparator BJ2 is coupled with the second reference voltage supply end Vrf2, the fourth end of the second comparator BJ2 is coupled with the set level supply end VCC, the fifth end of the second comparator BJ2 is coupled with the third end of the fourth switching tube Q4, and the second end of the fourth switching tube Q4 is coupled with the second end of the second signal processing sub-circuit 3242 and the second end of the drive sub-circuit 3241.

Similarly, the second comparator BJ2 samples for the first energy storage circuit 31, i.e., at the first end of the storage capacitor EC1, by utilizing the third resistor R3 and the fourth resistor R4 to obtain the first energy storage voltage, compares the first energy storage voltage with the second reference voltage, controls the fourth switching tube Q4 ON or OFF, and further controls the fourth control signal of the drive sub-circuit 3241 from the second signal processing sub-circuit 3242, i.e., control the second signal processing sub-circuit 3242 to send or not send the fourth control signal to the drive sub-circuit 3241. The corresponding control process is described in the relevant text of FIG. 5 and is not repeated herein.

Further, in an embodiment, the second comparison circuit 3245 also includes a sixth resistor (not marked on the figure); the first end of the sixth resistor is coupled with the first end of the second comparator BJ2, and the second end of the sixth resistor is coupled with the fifth end of the second comparator BJ2; the sixth resistor may adjust the comparison of the first energy storage voltage with the second reference voltage into the comparison of the input voltage with the fourth threshold range, send a second comparison signal 1 in case of higher than the fourth threshold range, and send a second comparison signal 0 in case of lower than the fourth threshold range to avoid frequent comparison by the second comparator BJ2 caused by unstable electrical signals and interference signals, in which the corresponding ON/OFF control is not stable, affecting the stability of the whole work of the voltage holding circuit 30.

It is worth noting that, as for the fourth threshold range, the lower limit is the difference between the second reference voltage and the second stepped voltage, while the upper limit is the sum of the second reference voltage and the second stepped voltage.

Furthermore, the second stepped voltage may be determined based on the resistance of the sixth resistor, i.e., regulate the resistance of the sixth resistor to effectively regulate the second stepped voltage so as to adjust the comparison state of the second comparator BJ2 to adapt to practical application scenarios. However, the present disclosure is not limited to the embodiments described herein.

In some embodiments, the third switching tube Q3 and the fourth switching tube Q4 may be a MOS tube, a triode, a thin-film transistor, a field-effect transistor, one of any other reasonable switching tubes, or a relay. However, the present disclosure is not limited to the embodiments described herein.

It is worth noting that to distinguish the two ends of the above switching tubes except for the control end, one pole is called the first end and the other pole is called the second end. If the switching tube is a triode, in some embodiments, the control end, i.e., the third end, may be a base pole, the first end may be a collector and the second end may be an emitter; or, specifically, the third end may be a base pole, the first end may be an emitter and the second end may be a collector.

If the switching tube is a MOS tube, a thin-film transistor or a field-effect transistor, in some embodiments, the third end may be a grid, the first end may be a drain, and the second end may be a source; or, in some embodiments, the third end may be a grid, the first end may be a source and the second end may be a drain.

Wherein, if the switching tube is a MOS tube, a thin-film transistor or a field-effect transistor, in some embodiments, the switching tube may be a composite transistor or a monolithic transistor. However, the present disclosure is not limited to the embodiments described herein.

It can be understood that in this embodiment, the first energy storage circuit 31, the second energy storage circuit 101, the third energy storage circuit 321, the first switch sub-circuit 322, the second switch sub-circuit 323, the protection sub-circuit 325, the first sampling circuit 33, the second sampling circuit 34, the drive sub-circuit 3241 and the peripheral circuit 3247 are same with the first energy storage circuit 21, the second energy storage circuit 101, the third energy storage circuit 221, the first switch sub-circuit 222, the second switch sub-circuit 223, the protection sub-circuit 225, the first sampling circuit 23, the second sampling circuit 24, the drive sub-circuit 2241 and the peripheral circuit 2247 respectively. Refer to FIGS. 2-4 and relevant text for details. No more description is made herein.

For the convenience of understanding, the work and control mode of the voltage holding circuit 30 is divided into two stages, i.e., stage A and stage B. In stage A, the external power source provides the input voltage to the input capacitor EC2, while in stage B, the external power source doesn't provide the input voltage to the input capacitor EC2, i.e., when the voltage holding circuit 30 is powered off, it can be known that the voltage holding circuit 30 is in stage A:

When inputting the voltage within the specification, i.e., the input voltage is within the first threshold range, the second energy storage voltage of the input capacitor EC2 is boosted to high voltage, i.e., boost and output the input voltage to the storage capacitor EC1, by providing a drive signal wave with a certain frequency and a dead zone to the second switching tube Q2 but not providing a drive signal wave to the first switching tube Q1, or providing another drive signal wave with phase opposite to the drive signal wave of the second switching tube Q2. The voltage conversion circuit 32 forms a boost circuit. When the first energy storage voltage of the storage capacitor EC1 is boosted to the set voltage, i.e., boost to the value within the second threshold range, stop the drive signal wave of the second switching tube Q2 to suspend the boosted energy storage of the storage capacitor EC1.

Wherein, because the voltage holding circuit 30 is not ideal, there is certain loss in the circuit, and the first energy storage voltage of the storage capacitor EC1 slowly drops. When it drops to the allowable lower limit of design, i.e., drop to the value lower than the first threshold range, a drive signal wave with a certain frequency and a dead zone is provided to the second switching tube Q2 again so as to ensure that the first energy storage voltage of the storage capacitor EC1 is always held within the allowable design value to effectively realize power-outage holding or low-voltage input compensation.

### Stage B:

When the input voltage drops, the first energy storage voltage of the storage capacitor EC1 is bucked and outputted to the input capacitor EC2 to supply the voltage for the input capacitor EC2 or a load power circuit connected to the input capacitor EC2 with a view to extending the power hold-up time. The method includes that when the second energy storage voltage of the input capacitor EC2 drops to the lowest set limit, i.e., drop to the value lower than the first threshold range, a drive signal wave with a certain frequency and a dead zone is provided to the first switching tube Q1, and the drive signal wave is not provided to the second switching tube Q2, so that the voltage conversion circuit 32 forms a buck circuit to output the first energy storage voltage of the storage capacitor EC1 to the input capacitor EC2.

It can be understood that to ensure holding a normal voltage of the input capacitor EC2 during bucking, the second energy storage voltage of the input capacitor EC2 and the first energy storage voltage of the storage capacitor EC1 may be simultaneously detected to realize the drive control for the first switching tube Q1 and the second switching tube Q2. Wherein, when the first energy storage voltage is within the first threshold range, i.e., the voltage of the input capacitor EC2 as a load or of the external load power circuit is within the normal work voltage range, buck control may not work or may be omitted.

From this, in some embodiments, the control mode may be that the control circuit 324 sends a boost drive signal or a buck drive signal with relevant law, and the hardware or the software detects, cuts and sends the drive signal to the voltage conversion circuit 32 to effectively simplify the control and to provide a variable frequency function.

In the above scheme, a storage capacitor EC1 and a voltage conversion circuit 32 are added in design to boost and output the input voltage to the storage capacitor EC1 to store energy, so that when the input voltage of the power source is low, even small capacitance capacitors may store more energy, greatly reducing the size and the cost of the voltage holding circuit 30.

And, the boosting and bucking function of the voltage holding circuit 30 only works as needed; compared with traditional continuous boost circuits, the requirements for specifications of various components in the circuit are lower, and the size and the cost are lower, without influence on the voltage stress of a normal power circuit.

When the input capacitor EC2 works normally, the input voltage from the power source is boosted and outputted to the storage capacitor EC1; when the power source is OFF, the energy stored in the storage capacitor EC1 is released to the input capacitor EC2. The advantages are that because the input voltage is stored in the storage capacitor EC1 after being boosted, the capacitance of the storage capacitor EC1 may be lower, and it is not necessary to hold the control state of boost energy storage continuously, realizing very low energy consumption of the energy storage circuit. When the second energy storage voltage of the storage capacitor EC1 reaches a set value, i.e., when the second energy storage voltage is within the second threshold range, suspend boosting, and after the second energy storage voltage is lower than the second threshold range, restart boosting; corresponding components may be smaller than that of traditional circuits. In a power-off state, to hold the power supply to a load, the energy in the storage capacitor EC1 is released to the input capacitor EC2; when the first energy storage voltage is within the first threshold range, i.e., the power voltage of the input capacitor EC2 as a load or of the external load power circuit is within the normal work voltage range, buck control may not work or may be omitted.

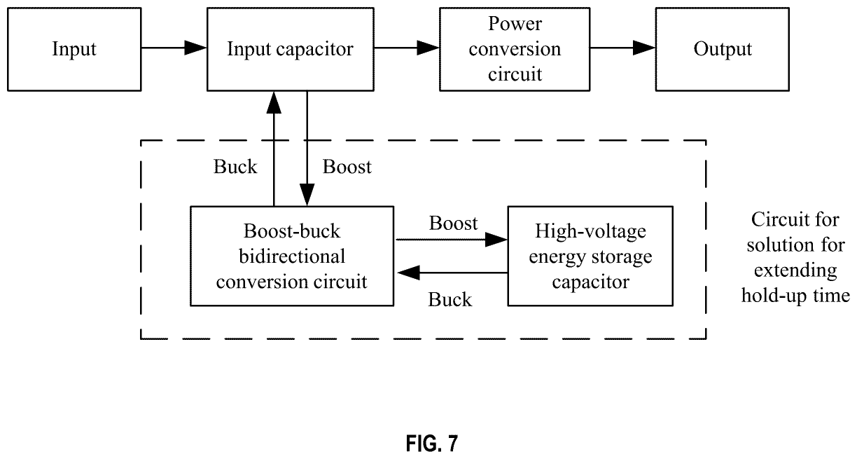

Referring to FIG. 7, FIG. 7 illustrates a framework schematic diagram of a signal processing logic of a voltage delay holding circuit.

It can be understood that the voltage delay holding circuit is corresponding to the voltage holding circuit 10, the voltage holding circuit 20 or the voltage holding circuit 30 in this application, a boost-buck bidirectional conversion circuit is corresponding to the voltage conversion circuit 12, the voltage conversion circuit 22 or the voltage conversion circuit 32, a high-voltage energy storage capacitor is corresponding to the first energy storage circuit 11, the first energy storage circuit 21 or the first energy storage circuit 31 and an input capacitor is corresponding to the second energy storage circuit 101; it can be known that the input capacitor receives the input voltage from the power source and sends the input voltage to the power conversion circuit and the boost-buck bidirectional conversion circuit, the power conversion circuit converts the input voltage and outputs to a load power circuit, and the boost-buck bidirectional conversion circuit is matched with the high-voltage energy storage capacitor to realize the power-outage delay by utilizing the input voltage.

In an embodiment, taking the input voltage of 40 Vdc-72 Vdc as an example, to meet the hold-up time≥2 ms with the input 40 Vdc and the output 1100 W, the voltage delay holding circuit is added.

For low-voltage DC input applications, the energy storage of the capacitor is 0.5CV\hat{ }2. A very large input capacitor is needed to achieve the hold-up time. The size and the number of the input capacitors have an impact on the power density of the power source.

The boost-buck bidirectional conversion circuit and the high-voltage energy storage capacitor which are simple and cost effective are conducive to reducing the capacitors for hold-up time so as to reduce sizes and costs.

In normal input, the boost-buck bidirectional conversion circuit boosts the low voltage input to high voltage and the high-voltage energy storage capacitor stores the high voltage. When the input voltage drops, the boost-buck bidirectional conversion circuit bucks and outputs the energy of the high-voltage energy storage capacitor to the input capacitor to extend the hold-up time.

It should be noted that: 1. in normal input, the boost function of the boost-buck bidirectional conversion circuit is activated and the power is outputted from the input capacitor to the high-voltage energy storage capacitor and is boosted to 155 Vdc for storage.

Why the input voltage is boosted to 155 Vdc:

½*C*0.8(Vh²−Vl²)=Pout/Eff*2 ms; C is the capacitance of the high-voltage energy storage capacitor, 330 uF; 0.8 is the capacitance tolerance; Vh=150V is the voltage after boosting; Vl=40÷60%=66.7 Vdc is the lowest energy storage voltage to hold the output; 60% is the duty cycle of buck; Pout is the output power; Eff is the conversion efficiency.

2. In a power-off state (the input voltage is lower than 40 Vdc), the buck function of the boost-buck bidirectional conversion circuit is activated, the power is outputted from the high-voltage energy storage capacitor to the input capacitor, and the voltage of the input capacitor is held at 40 Vdc.

It should be noted that different from traditional buck/boost converters, the boost-buck bidirectional conversion circuit doesn't need a fixed frequency PWM signal with duty cycle control. DSP of the boost-buck bidirectional conversion circuit can determine the duty cycle of simple and fixed PWM signals for controlling MOSFET based on the voltage of the input capacitor and the high-voltage energy storage capacitor with boost and buck functions.

The boost-buck bidirectional conversion circuit also can sense and measure the input voltage drop by comparator or similar digital solution to quickly hold the input voltage.

Wherein: 1. If Input≥43.5 Vdc, MCU of the boost-buck bidirectional conversion circuit constantly sends a PWM BB boost wave and a PWM BB buck wave, 200 kHz, boost duty cycle 30%, buck duty cycle 70% (complementary), dead zone 400 ns. Practically, duty cycle of PWM BB boost D1=20% and duty cycle of PWM BB buck D2=60%. If Vin≤37 Vdc, PWM wave is stopped.

2. A circuit is created with a comparator to detect the voltage of the high-voltage energy storage capacitor and the input capacitor and control whether the PWM signal is sent to the corresponding switch tube through the drive chip.

3. The comparator detects the voltage of the high-voltage energy storage capacitor, and is disabled when the voltage is higher than 155 Vdc (i.e., lower down the PWM BB boost; normally ON by default); the high-voltage energy storage capacitor is a 200V voltage resistant capacitor. The comparator detects the voltage of the input capacitor and is enabled when the voltage is lower than 39.5 Vdc (lower down the PWM BB buck by default, normally OFF).

4. Instantaneous current of buck and boost is uncontrollable. Therefore, a sampling resistor is added to output to MCU by sampling to control PWM wave. Under the premise of ensuring sufficient output voltage, the Imax should be designed as minimum value. For example, the design protection current is 50 A.

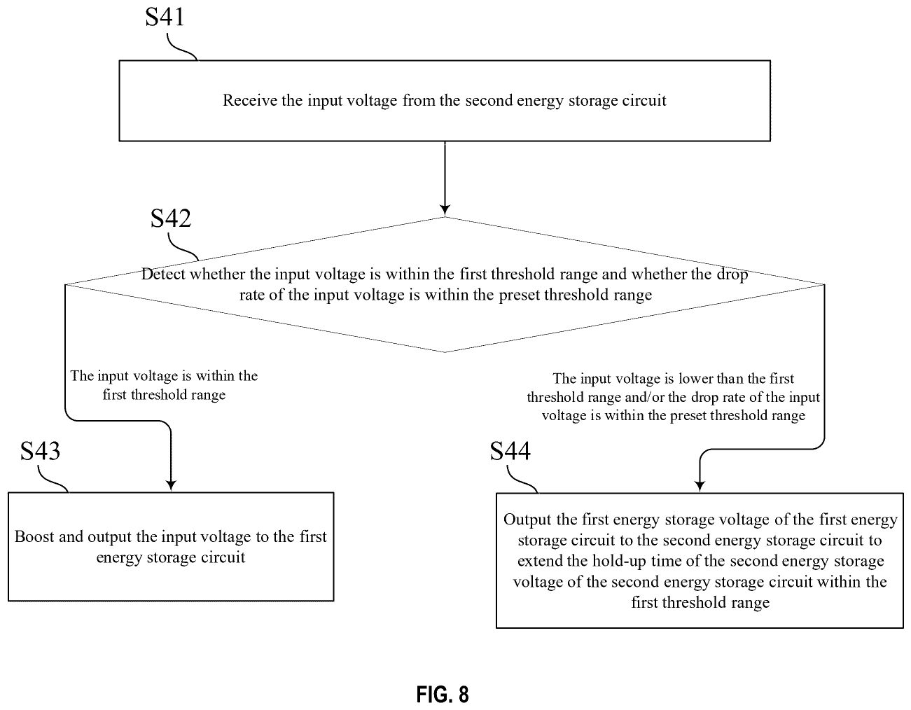

The embodiments of this application also provide a voltage holding method. Referring to FIG. 8, FIG. 8 illustrates a process flow schematic diagram of an embodiment of the voltage holding method in this application. In some embodiments, the voltage holding method may include the following steps:

S41: receive the input voltage from the second energy storage circuit.

It can be understood that, the voltage holding method in this embodiment is a method that when the input voltage from the external power source drops or stops, the voltage holding circuit extends hold-up time of the voltage provided to the input capacitor or the load power circuit connected to the input capacitor. Wherein, in some embodiments, the voltage holding circuit includes a first energy storage circuit and a voltage conversion circuit which is coupled between the first energy storage circuit and the second energy storage circuit.

In some embodiments, the second energy storage circuit receives the input voltage from the external power source as a power load or provides the input voltage to the load power circuit connected to the second energy storage circuit.

Wherein, the voltage conversion circuit receives the input voltage from the second energy storage circuit.

S42: detect whether the input voltage is within the first threshold range and whether the drop rate of the input voltage is within the preset threshold range.

Further, the voltage conversion circuit obtains the input voltage from the second energy storage circuit by sampling and detects whether the input voltage is within the first threshold range and whether the drop rate of the input voltage is within the preset threshold range.

Wherein, if the input voltage is within the first threshold range, execute S43 and if the input voltage is lower than the first threshold range and/or the drop rate of the input voltage is within the preset threshold range, execute S44.

S43: boost and output the input voltage to the first energy storage circuit.

Wherein, when it is confirmed that the input voltage is within the first threshold range, specifically, the voltage conversion circuit boosts and outputs the input voltage to the first energy storage circuit to store the boosted input voltage into the first energy storage circuit to form a first energy storage voltage.

S44: output the first energy storage voltage of the first energy storage circuit to the second energy storage circuit to extend the hold-up time of the second energy storage voltage of the second energy storage circuit within the first threshold range.

In some embodiments, when it is confirmed that the input voltage is lower than the first threshold range and/or the drop rate of the input voltage is within the preset threshold range, the voltage conversion circuit outputs the first energy storage voltage of the first energy storage circuit to the second energy storage circuit to store the first energy storage voltage into the first energy storage circuit and superpose the current energy storage voltage of the second energy storage circuit with a view to extending the hold-up time of the second energy storage voltage of the second energy storage circuit within the first threshold range until the first energy storage voltage of the first energy storage circuit and the current energy storage voltage of the second energy storage circuit are consumed to voltage below critical holding value. so that the second energy storage circuit can complete necessary work during the hold-up time of the second energy storage voltage.

It is worth noting that the first threshold range can be understood as a voltage range of holding normal work of the second energy storage circuit or an external load connected to the second energy storage circuit, such as the input capacitor, or a power output range of holding the normal work of a storage chip, a signal processing chip or a MCU circuit, and may be any reasonable threshold range such as 25V-36V, 36V-50V, or 50V-70V. It may be determined based on a practical application scenario. However, the present disclosure is not limited to the embodiments described herein.

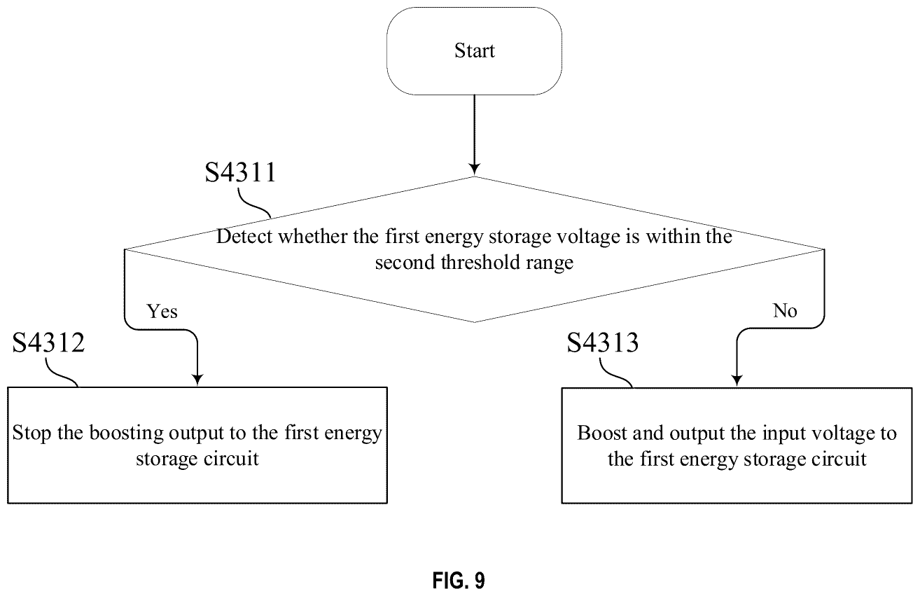

Referring to FIG. 9, FIG. 9 illustrates a process flow schematic diagram of an embodiment of S43 in FIG. 8. In an embodiment, besides S41-S44, the voltage holding method in this application further includes some more specific steps. In some embodiments, S43 may also include the following steps:

S4311: detect whether the first energy storage voltage is within the second threshold range.

It can be understood that, the voltage conversion circuit also may obtain whether the first energy storage voltage of the first energy storage circuit is within the second threshold range by sampling.

Wherein, if the first energy storage voltage is within the second threshold range, execute S4312, and if the first energy storage voltage is lower than the second threshold range, execute S4313.

S4312: stop the boosting output to the first energy storage circuit.

In some embodiments, when it is confirmed that the first energy storage voltage of the first energy storage circuit is within the second threshold range, the voltage conversion circuit stops boosting and outputting to the first energy storage circuit, i.e., disconnect the connection between the first energy storage circuit and the second energy storage circuit, to try to reduce the power loss of the voltage conversion circuit and the first energy storage circuit when the second energy storage circuit works normally with the input voltage from the power source or the second energy storage circuit utilizes the input voltage to supply power to an external load to drive the normal work of the load. Compared with traditional boost circuits, i.e., those boost circuits in continuous operation, the embodiment has lower requirements for specifications of components in the voltage conversion circuit and realizes smaller size and lower cost of circuits without influence of voltage stress of normal power circuits.

S4313: boost and output the input voltage to the first energy storage circuit.

Further, because it is inevitable that there will be some power loss in the voltage conversion circuit and the first energy storage circuit, the first energy storage voltage of the first energy storage circuit slowly drops. When it is confirmed that the first energy storage voltage of the first energy storage circuit is lower than the second threshold range, the voltage conversion circuit boosts the input voltage again and outputs it to the first energy storage circuit, and the first energy storage voltage of the first energy storage circuit is boosted to the voltage within the second threshold range with a view to holding the first energy storage voltage within the allowable design range.

It is worth noting that, the second threshold range may be understood as a reasonable voltage range in which the first energy storage circuit can utilize the first energy storage voltage of the first energy storage circuit to boost the second energy storage voltage to the voltage within the first threshold range again when the second energy storage voltage of the second energy storage circuit is lower than the first threshold range. It may be determined based on a practical application scenario. However, the present disclosure is not limited to the embodiments described herein.

In some embodiments, the lower voltage limit of the second threshold range is higher than the upper voltage limit of the first threshold range, i.e., the voltage within the second threshold range is greater than the voltage within the first threshold range; or, the lower voltage limit of the second threshold range is lower than the upper voltage limit of the first threshold range, and the upper voltage limit of the second threshold range is higher than the upper voltage limit of the first threshold range, i.e., the second threshold range may partially overlap with the first threshold range, but at least, the voltage within a portion of the second threshold range is higher than any voltage within the first threshold range, and it may be any reasonable threshold range such as 50V-80V, 70V-90V or 100V-120V It may be determined based on a practical application scenario. However, the present disclosure is not limited to the embodiments described herein.

It can be understood that, the second threshold range may be higher than or within the normal work voltage range of the second energy storage circuit or an external load connected to the second energy storage circuit so that the voltage conversion circuit may output the first energy storage voltage of the first energy storage circuit to the second energy storage circuit by bucking or without bucking, i.e., the voltage conversion circuit may output by bucking, output without bucking or omit the output with relevant switches, so as to save the corresponding buck circuit configuration and buck control.

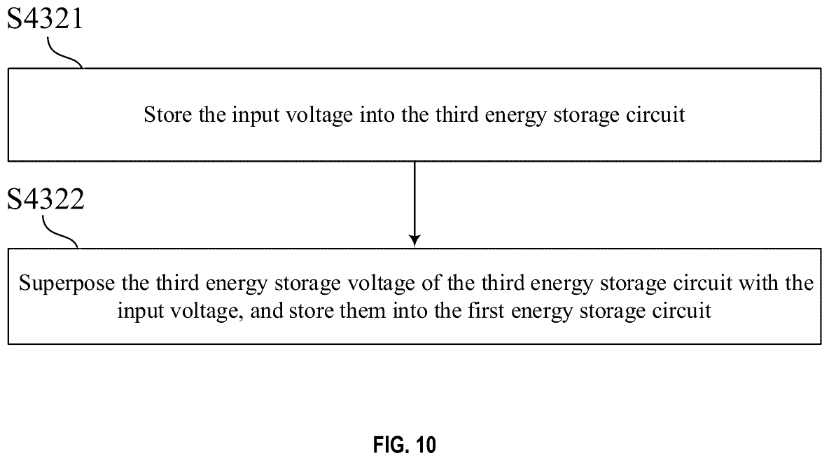

Referring to FIG. 10, FIG. 10 illustrates a process flow schematic diagram of another embodiment of S43 in FIG. 8. In an embodiment, besides S41-S44, the voltage holding method in this application further includes some more specific steps. In some embodiments, S43 may include the following steps:

S4321: store the input voltage into the third energy storage circuit.

It can be understood that, the voltage conversion circuit further includes a third energy storage circuit, a first switch sub-circuit, a second switch sub-circuit and a control circuit; the third energy storage circuit is coupled with the second energy storage circuit, the first switch sub-circuit and the second switch sub-circuit, the first switch sub-circuit is coupled with the second switch sub-circuit, the first energy storage circuit and the control circuit, the second switch sub-circuit is coupled with the control circuit and the control circuit is coupled with the second energy storage circuit.

In some embodiments, the third energy storage circuit receives the input voltage from the second energy storage circuit to store the input voltage into the third energy storage circuit.

S4322: superpose the third energy storage voltage of the third energy storage circuit with the input voltage, and store them into the first energy storage circuit.

Further, the control circuit obtains the input voltage from the second energy storage circuit by sampling, triggers the second switch sub-circuit ON at a set interval, superposes the third energy storage voltage of the third energy storage circuit with the input voltage and stores them into the first energy storage circuit when the input voltage is within the first threshold range, i.e., the second switch sub-circuit and the third energy storage circuit are combined to form a boost circuit to boost and output the input voltage to the first energy storage circuit.

It is worth noting that when the control circuit triggers the second switch sub-circuit ON, it may trigger the first switch sub-circuit ON to boost and output the input voltage to the first energy storage circuit through the first switch sub-circuit and trigger the first switch sub-circuit OFF to boost and output the input voltage to the first energy storage circuit through the internal path formed by semiconductor characteristics of the first switch sub-circuit, such as an electric path formed by body diode in the first switch sub-circuit.

In some embodiments, to simplify the control mode of the control circuit, the control circuit may realize the ON-OFF control of the second switch sub-circuit and the first switch sub-circuit by two synchronous PWM control signals in opposite phases so as to boost and output the input voltage to the first energy storage circuit. However, the present disclosure is not limited to the embodiments described herein.

Furthermore, the set interval may be a half cycle of PWM control signal for the second switch sub-circuit and also may be an interval set in the program. It may be determined based on a practical application scenario. However, the present disclosure is not limited to the embodiments described herein.

It can be understood that in some other embodiments, the voltage holding circuit also includes some other more specific circuit units to implement other more specific control methods accordingly. Refer to FIG. 1-FIG. 6 and relevant text for details. No more description is made herein.

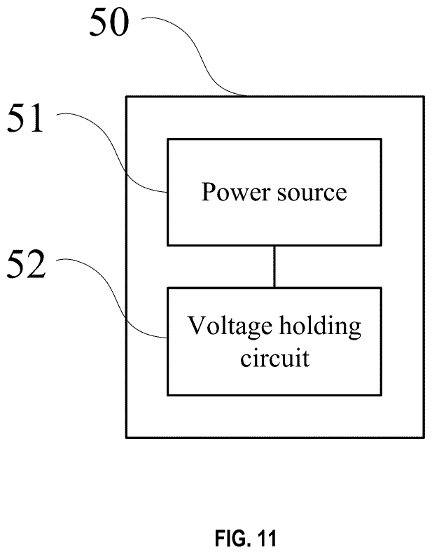

The embodiments of this application also provide a power circuit. Referring to FIG. 11, FIG. 11 illustrates a framework schematic diagram of an embodiment of the power circuit in this application. In this embodiment, the power circuit 50 includes a coupled power source 51 and a coupled voltage holding circuit 52.

It should be noted that the voltage holding circuit 52 in this embodiment is a voltage holding circuit 10, a voltage holding circuit 20 or a voltage holding circuit 30 in any of embodiments. Refer to FIG. 1-FIG. 6 and relevant text for details. No more description is made herein.

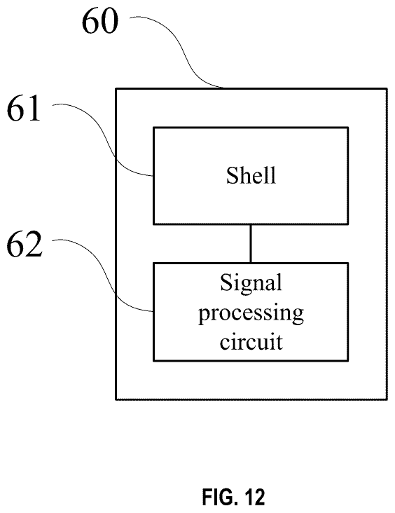

The embodiments of this application also provide an electronic device. Referring to FIG. 12, FIG. 12 illustrates a framework schematic diagram of an embodiment of the electronic device in this application. In this embodiment, the electronic device 60 includes a shell 61 and a signal processing circuit 62 connected to the shell 61.

In some embodiments, the electronic device 60 may be a storage medium, an intelligent terminal device, a UAV, an electric toy, or other reasonable electronic and mechanical devices. This embodiment is not intended to limit these devices. However, the present disclosure is not limited to the embodiments described herein.

It should be noted that a signal processing circuit 62 in this embodiment is the voltage holding circuit 10, the voltage holding circuit 20, the voltage holding circuit 30, or the power circuit 50 in above embodiments. Refer to FIG. 1-FIG. 6, FIG. 11 and relevant text for details. No more description is made herein.

The beneficial effect of the embodiments of this application is that different from related arts, the voltage holding circuit in this application receives the input voltage from the second energy storage circuit, boosts and outputs the input voltage to the first energy storage circuit when the input voltage is within a first threshold range, and outputs the first energy storage voltage of the first energy storage circuit to the second energy storage circuit when the input voltage is lower than the first threshold range, i.e., the input voltage drops, so as to effectively hold the second energy storage voltage of the second energy storage circuit within the first threshold range. Therefore, the voltage holding circuit can effectively realize power-outage holding or low-voltage input compensation without installing additional energy storage components or increasing the energy storage voltage during discharge. The voltage holding circuit can also respond to the drop of the input voltage and/or the drop trend of the input voltage to quickly boost the voltage of the second energy storage circuit with low cost and small size. It is convenient for smaller size and lower cost. In addition, a voltage conversion circuit for both boosting and bucking can effectively save circuit components and reduce the size of energy storage components with a view to effectively simplifying the circuit control.

The above content is only the embodiments in this application and constitutes no limitation to the scope of the patent in this application. Any equivalent structure or equivalent process transformation made by reference of the specification and accompanying drawings in this application, or direct or indirect application in other related technical fields are included in the protection scope of the patent of this application.

What is claimed is:

1. A voltage holding circuit, comprising:
a first energy storage circuit; and
a voltage conversion circuit coupled between the first energy storage circuit and a second energy storage circuit to receive an input voltage from the second energy storage circuit, boost and output the input voltage to the first energy storage circuit when the input voltage is within a first threshold range, and output a first energy storage voltage of the first energy storage circuit to the second energy storage circuit when the input voltage is lower than the first threshold range or when a drop rate of the input voltage is within a preset threshold range, to extend a hold-up time of a second energy storage voltage of the second energy storage circuit within the first threshold range.

2. The voltage holding circuit according to claim 1, wherein:
when the first energy storage voltage is within a second threshold range, the voltage conversion circuit stops boosting and outputting to the first energy storage circuit; and
when the first energy storage voltage is lower than the second threshold range, the voltage conversion circuit boosts and outputs the input voltage to the first energy storage circuit.

3. The voltage holding circuit according to claim 1, wherein:
the voltage conversion circuit comprises: a third energy storage circuit, a first switch sub-circuit, a second switch sub-circuit, and a control circuit;
the third energy storage circuit is coupled with the second energy storage circuit, the first switch sub-circuit, and the second switch sub-circuit;
the first switch sub-circuit is coupled with the second switch sub-circuit, the first energy storage circuit, and the control circuit;
the second switch sub-circuit is coupled with the control circuit; and
the control circuit is coupled with the second energy storage circuit;
and wherein:
the third energy storage circuit is configured to receive the input voltage from the second energy storage circuit; and
when the input voltage is within the first threshold range, the control circuit is configured to obtain the input voltage by sampling, trigger the second switch sub-circuit ON at a set interval, superpose the third energy storage voltage of the third energy storage circuit with the input voltage and store the superimposed voltage into the first energy storage circuit, and
when the input voltage is lower than the first threshold range or a drop rate of the input voltage is within the preset threshold range, the control circuit is configured to trigger the first switch sub-circuit ON and the second switch sub-circuit OFF, and output the first energy storage voltage to the second energy storage circuit.

4. The voltage holding circuit according to claim 3, wherein
the voltage conversion circuit further comprises a protection sub-circuit coupled between the second switch sub-circuit and the first energy storage circuit to limit the current between the second switch sub-circuit and the first energy storage circuit within a third threshold range.

5. The voltage holding circuit according to claim 3, wherein:
the voltage conversion circuit further comprises a first sampling circuit coupled with the first energy storage circuit and the control circuit to obtain the first energy storage voltage by sampling and send the first energy storage voltage to the control circuit; or
the voltage conversion circuit further comprises a second sampling circuit coupled with the second energy storage circuit and the control circuit to obtain the input voltage by sampling and send the input voltage to the control circuit.

6. The voltage holding circuit according to claim 5, wherein:
the control circuit comprises a first signal processing sub-circuit and a drive sub-circuit;
the first signal processing sub-circuit is coupled with the second sampling circuit and the drive sub-circuit;
the drive sub-circuit is coupled with the first switch sub-circuit and the second switch sub-circuit;
the first signal processing sub-circuit is configured to receive the input voltage from the second sampling circuit, generate a second control signal based on the input voltage or the voltage drop rate, and send the second control signal to the drive sub-circuit; and
the drive sub-circuit is configured to send a second drive signal to the second switch sub-circuit to trigger the second switch sub-circuit ON or OFF; or
wherein:
the first signal processing sub-circuit is coupled with the first sampling circuit;
the first signal processing sub-circuit is configured to receive the first energy storage voltage from the first sampling circuit, generate a first control signal based on the first energy storage voltage, and send the first control signal to the drive sub-circuit; and
the drive sub-circuit is configured to send a first drive signal to the first switch sub-circuit to trigger the first switch sub-circuit ON or OFF.

7. The voltage holding circuit according to claim 5, wherein:
the control circuit comprises: a second signal processing sub-circuit, a first comparison circuit, a third switch sub-circuit, and a drive sub-circuit;
the second signal processing sub-circuit is coupled with the third switch sub-circuit and the drive sub-circuit;
the first comparison circuit is coupled with the second sampling circuit and the third switch sub-circuit;
the first comparison circuit is configured to receive the input voltage from the second sampling circuit, obtain a first comparison signal by comparing the input voltage with a first reference voltage, and send the first comparison signal to the third switch sub-circuit to trigger the third switch sub-circuit ON or OFF;
the second signal processing sub-circuit is configured to send a third control signal to the drive sub-circuit when the third switch sub-circuit is OFF; and
the drive sub-circuit is configured to send a third drive signal to the second switch sub-circuit under the action of the third control signal to trigger the second switch sub-circuit ON or OFF; or
wherein:
the control circuit further comprises: a second comparison circuit, and a fourth switch sub-circuit;
the second comparison circuit is coupled with the first sampling circuit, the fourth switch sub-circuit, and the second signal processing sub-circuit;
the second comparison circuit is configured to receive the first energy storage voltage from the first sampling circuit, obtain a second comparison signal by comparing the first energy storage voltage with a second reference voltage, and send the second comparison signal to the fourth switch sub-circuit to trigger the fourth switch sub-circuit ON or OFF;
the second signal processing sub-circuit is configured to send a fourth control signal to the drive sub-circuit when the fourth switch sub-circuit is OFF; and
the drive sub-circuit is configured to send a fourth drive signal to the first switch sub-circuit under the action of the fourth control signal to trigger the first switch sub-circuit ON or OFF.

8. The voltage holding circuit according to claim 7, wherein:
the first comparison circuit comprises: a first resistor, a second resistor, and a first comparator;
the third switch sub-circuit comprises: a third switching tube;
the first end of the first resistor is coupled with the first end of the first energy storage circuit;
the second end of the first resistor is coupled with the first end of the second resistor and the first end of the first comparator;
the second end of the second resistor is coupled with the third end of the first comparator and the first end of the third switching tube, and is grounded;
the second end of the first comparator is coupled with the second reference voltage supply end;
the fourth end of the first comparator is coupled with a set level supply end;
the fifth end of the first comparator is coupled with the third end of the third switching tube; and
the second end of the third switching tube is coupled with the first end of the second signal processing sub-circuit and the first end of the drive sub-circuit; or wherein
the second comparison circuit comprises a third resistor, a fourth resistor, and a second comparator;
the fourth switch sub-circuit comprises a fourth switching tube;
the first end of the third resistor is coupled with the first end of the second energy storage circuit;
the second end of the third resistor is coupled with the first end of the fourth resistor and the first end of the second comparator;
the second end of the fourth resistor is coupled with the third end of the second comparator and the first end of the fourth switching tube, and is grounded;
the second end of the second comparator is coupled with the first reference voltage supply end;
the fourth end of the second comparator is coupled with the set level supply end;
the fifth end of the second comparator is coupled with the third end of the fourth switching tube; and
the second end of the fourth switching tube is coupled with the second end of the second signal processing sub-circuit and the second end of the drive sub-circuit.

9. The voltage holding circuit according to claim 8, wherein:
the first comparison circuit further comprises a fifth resistor, wherein the first end is coupled with the first end of the first comparator, and the second end is coupled with the fifth end of the first comparator; or
the second comparison circuit further comprises a six resistor, wherein the first end is coupled with the first end of the second comparator, and the second end is coupled with the fifth end of the second comparator.

10. The voltage holding circuit according to claim 7, wherein:
the voltage conversion circuit further comprises a peripheral circuit coupled with the drive sub-circuit and the first switch sub-circuit.

11. The voltage holding circuit according to claim 3, wherein:
the first energy storage circuit comprises a storage capacitor;
the second energy storage circuit comprises an input capacitor;
the third energy storage circuit comprises a first inductor;
the first switch sub-circuit comprises a first switching tube; and
the second switch sub-circuit comprises a second switching tube; wherein:
the first end of the input capacitor is coupled with the second energy storage circuit and the first end of the first inductor;
the second end of the first inductor is coupled with the second end of the first switching tube and the first end of the second switching tube;
the first end of the first switching tube is coupled with the first end of the storage capacitor;
the second end of the input capacitor is coupled with the second end of the second switching tube and the second end of the storage capacitor, and is grounded;
the third end of the first switching tube is coupled with the first end of the control circuit; and
the third end of the second switching tube is coupled with the second end of the control circuit.

12. A voltage holding method, comprising:
receiving an input voltage from a second energy storage circuit;
detecting whether the input voltage is within a first threshold range and whether a drop rate of the input voltage is within a preset threshold range;
boosting and outputting the input voltage to a first energy storage circuit when the input voltage is within the first threshold range; and
outputting a first energy storage voltage of the first energy storage circuit to the second energy storage circuit and boosting a second energy storage voltage of the second energy storage circuit to a value within the first threshold range when the input voltage is lower than the first threshold range, or the drop rate of the input voltage is within the preset threshold range.

13. The voltage holding method according to claim 12, wherein the boosting and outputting the input voltage to the first energy storage circuit further comprises:
detecting whether the first energy storage voltage is within a second threshold range;
in response to the first energy storage voltage being within the second threshold range, stopping the boosting and outputting the input voltage to the first energy storage circuit; and
in response to the first energy storage voltage being outside the second threshold range, boosting and outputting the input voltage to the first energy storage circuit.

14. The voltage holding method according to claim 12, wherein the boosting and outputting the input voltage to the first energy storage circuit comprises:
storing the input voltage to a third energy storage circuit; and
superposing a third energy storage voltage of the third energy storage circuit with the input voltage, and storing them to the first energy storage circuit.

15. A power circuit, comprising:
a second energy storage circuit; and
a voltage holding circuit, wherein the second energy storage circuit is coupled with the voltage holding circuit and a power source to receive an input voltage from the power source and send the input voltage to a voltage conversion circuit,
wherein the voltage holding circuit comprises:
a first energy storage circuit; and
the voltage conversion circuit coupled between the first energy storage circuit and the second energy storage circuit to receive an input voltage from the second energy storage circuit, boost and output the input voltage to the first energy storage circuit when the input voltage is within a first threshold range, and output the first energy storage voltage of the first energy storage circuit to the second energy storage circuit when the input voltage is lower than the first threshold range or when a drop rate of the input voltage is within a preset threshold range, to extend a hold-up time of a second energy storage voltage of the second energy storage circuit within the first threshold range.

16. An electronic device, comprising:
a shell; and
a signal processing circuit,
wherein the signal processing circuit comprises:
a first energy storage circuit; and
a voltage conversion circuit coupled between the first energy storage circuit and a second energy storage circuit to receive an input voltage from the second energy storage circuit, boost and output the input voltage to the first energy storage circuit when the input voltage is within a first threshold range, and output a first energy storage voltage of the first energy storage circuit to the second energy storage circuit when the input voltage is lower than the first threshold range or when a drop rate of the input voltage is within a preset threshold range, to extend a hold-up time of a second energy storage voltage of the second energy storage circuit within the first threshold range.
